(19) United States
(12) Patent Application Publication
(10) Pub. No.: US 2015/0114243 A1
(43) Pub. Date: Apr. 30, 2015

(54) CYLINDRICAL PRINTING PLATE PRECURSOR AND PROCESS FOR PRODUCING SAME, AND CYLINDRICAL PRINTING PLATE AND PROCESS FOR MAKING SAME

(71) Applicant: FUJIFILM CORPORATION, Tokyo (JP)

(72) Inventor: Yusuke NAMBA, Haibara-gun (JP)

(73) Assignee: FUJIFILM Corporation, Tokyo (JP)

(21) Appl. No.: 14/591,169

(22) Filed: Jan. 7, 2015

Related U.S. Application Data
(63) Continuation of application No. PCT/JP2013/075022, filed on Sep. 17, 2013.

(51) Int. Cl. B41C 1/10; B41N 1/20; B41N 1/22; B41C 1/18

(52) U.S. Cl. CPC B41C 1/1008; B41C 1/18; B41N 1/20; B41N 1/22
USPC 101/375; 101/401.1; 264/400; 264/265

(57) ABSTRACT

A cylindrical printing plate precursor of the present invention comprising a cured resin sheet formed into a cylindrical shape, the cylindrical printing plate precursor comprising an overlap margin part comprising opposite end parts of the cured resin sheet superimposed on one another, each end part of the cured resin sheet in the overlap margin part having a thickness that is smaller than the thickness of the cured resin sheet other than in the overlap margin part, and a joining part, in the overlap margin part, in which a hole providing communication between the opposite end parts of the cured resin sheet is filled with a cured resin, the overlap margin part having a specific width, the joining part having a specific size, and the joining part having a specific cross-sectional area in the plate surface direction.

### CROSS-REFERENCE TO RELATED APPLICATIONS

This application is a Continuation of PCT International Application No. PCT/JP2013/075022 filed on Sep. 17, 2013, which claims priority under 35 U.S.C. §119(a) to Japanese Patent Application No. 2012-202842 filed on Sep. 14, 2012. The contents of these applications are incorporated herein by reference in their entirety.

### TECHNICAL FIELD

The present invention relates to a cylindrical printing plate precursor and a process for producing same, and a cylindrical printing plate and a process for making same.

### BACKGROUND ART

As a process for forming a printing plate by forming asperities in a photosensitive resin layer layered on a support surface area, a method in which a recording layer formed using a photosensitive composition is exposed to UV light through an original image film to thus selectively cure an image area, and an uncured area is removed using a developer, the so-called ‘analogue plate making’, is well known.

A relief printing plate is a letterpress printing plate having a relief layer with asperities, and such a relief layer with asperities is obtained by patterning a recording layer comprising a photosensitive composition containing as a main component, for example, an elastomeric polymer such as a synthetic rubber, a resin such as a thermoplastic resin, or a mixture of a resin and a plasticizer, thus forming asperities. Among such relief printing plates, one having a soft relief layer is sometimes called a flexographic plate.

When a relief printing plate is made by analogue plate making, since an original image film employing a silver salt material is generally necessary, production time and cost for the original image film are incurred. Furthermore, since development of the original image film requires a chemical treatment, and treatment of development effluent is required, simpler plate making methods, for example, a method that does not use an original image film, a method that does not require development processing, etc. have been examined.

In recent years, methods for carrying out plate-making of a recording layer by scanning exposure without requiring an original image film have been investigated.

As a technique that does not require an original image film, a relief printing plate precursor in which a laser-sensitive mask layer element that can form an image mask is provided above a recording layer has been proposed (ref. e.g. Patent Documents 1 and 2). Such a process for making a precursor is called a ‘mask CTP method’ because an image mask having a similar function to that of an original image film is formed from a mask layer element by irradiation with a laser based on image data, but although no original image film is required, the subsequent plate-making process is a step of removing an uncured part by development involving exposure with UV light via an image mask, and there is still room for improvement in terms of development processing still being required.

As a process for making a printing plate that does not require a development step, the so-called ‘direct engraving CTP method’, in which a printing plate is made by directly engraving a recording layer by means of a laser, has often been proposed. The direct engraving CTP method is a method in which asperities forming a relief are directly formed by engraving by means of a laser, and it has the advantage that, unlike relief formation using an original image film, the relief shape can be freely controlled. Because of this, when forming an image such as an outline character, it is possible to engrave that region more deeply than another region, or in a fine halftone image, engraving with a shoulder can be carried out while taking into consideration resistance to printing pressure.

With regard to a plate material used in the direct engraving CTP method, a large number of binders, which determine the properties of a plate material, have been proposed, including one using a hydrophobic elastomer (rubber) (ref. e.g. Patent Documents 1 to 6) and one using a hydrophilic polyvinyl alcohol derivative (ref. e.g. Patent Document 7).

Furthermore, as a method for forming a cylindrical printing plate precursor from a printing plate precursor sheet, a method described in Patent Document 8 is known.

### PRIOR ART DOCUMENTS

### Patent Documents

Patent Document 1: U.S. Pat. No. 5,798,202

### Patent Document 2: U.S. 2008/0061036 A1

Patent Document 3: JP-A-2002-3665 (JP-A denotes a Japanese unexamined patent application publication)

### Patent Document 4: Japanese Patent No. 3438404

### Patent Document 5: JP-A-2004-262135

### Patent Document 6: JP-A-2001-121833

### Patent Document 7: JP-A-2006-2061

### Patent Document 8: JP-A-2010-76243

### SUMMARY OF THE INVENTION

### Problems to be Solved by the Invention

It is an object of the present invention to provide a cylindrical printing plate precursor that is excellent in terms of thickness precision and adhesive strength and a process for producing same.

### Means for Solving the Problems

The objects of the present invention have been attained by <1>, <6>, <15>, and <16> below. They are listed together with <2> to <5> and <7> to <14>, which are preferred embodiments.

<1> A cylindrical printing plate precursor comprising a cured resin sheet formed into a cylindrical shape, the cylindrical printing plate precursor comprising an overlap margin part comprising opposite end parts of the cured resin sheet superimposed on one another, each end part of the cured resin sheet in the overlap margin part having a thickness that is smaller than the thickness of the cured resin sheet other than in the overlap margin part, and a joining part, in the overlap margin part, in which a hole providing communication between the opposite end parts of the cured resin sheet is filled with a cured resin, the overlap margin part having a width of least 5 mm but no greater than 25 mm, the joining part having a size of at least 1 mm but no greater than 3 mm, and the joining part having a cross-sectional area in the plate surface direction of at last 5% but less than 80% relative to the cross-sectional area in the plate surface direction of the overlap margin part,
<2> the cylindrical printing plate precursor according to <1>, wherein the number of joining parts is 20 to 600,
<3> the cylindrical printing plate precursor according to <1> or <2>, wherein the number of joining parts is 50 to 200,
<4> the cylindrical printing plate precursor according to any one of <1> to <3>, wherein the joining part has a columnar shape,
<5> the cylindrical printing plate precursor according to any one of <1> to <4>, wherein the cylindrical printing plate precursor is a cylindrical printing plate precursor for laser engraving,
<6> a process for producing a cylindrical printing plate precursor, comprising (1) a step of preparing a cured resin sheet, (2) a step of forming a part of the cured resin sheet that becomes an overlap margin, (3) a step of forming a hole providing communication within an overlap margin part in which an overlap margin on the winding start end side of the cured resin sheet and an overlap margin on the winding finish end side are superimposed on one another, and (4) a step of forming a joining part by filling the hole with a cured curable resin composition, the overlap margin part having a width of at least 5 mm but no greater than 25 mm, the joining part having a size of at least 1 mm but no greater than 3 mm, and the hole having a cross-sectional area in the plate surface direction of at last 5% but less than 80% relative to the cross-sectional area in the plate surface direction of the overlap margin part,
<7> the process for producing a cylindrical printing plate precursor according to <6>, wherein step (4) comprises a step of injecting an uncured curable resin composition into the hole and a step of curing the uncured curable resin composition,
<8> the process for producing a cylindrical printing plate precursor according to <6> or <7>, wherein any one of step (2) to step (4) is a step that is carried out while fixing at least one end part of the cured resin sheet,
<9> the process for producing a cylindrical printing plate precursor according to any one of <6> to <8>, wherein the curable resin composition is a thermally curable resin composition,
<10> the process for producing a cylindrical printing plate precursor according to any one of <6> to <9>, wherein the hole is a through hole extending through the two overlap margins,
<11> the process for producing a cylindrical printing plate precursor according to any one of <6> to <10>, wherein the number of joining parts is 20 to 600,
<12> the process for producing a cylindrical printing plate precursor according to any one of <6> to <11>, wherein the number of joining parts is 50 to 200,
<13> the process for producing a cylindrical printing plate precursor according to any one of <6> to <12>, wherein the joining part has a columnar shape,
<14> the process for producing cylindrical printing plate precursor according to any one of <6> to <13>, wherein the cylindrical printing plate precursor is a cylindrical printing plate precursor for laser engraving,
<15> a process for making a cylindrical printing plate, comprising an engraving step of laser-engraving the cylindrical printing plate precursor according to any one of <1> to <5> or a cylindrical printing plate precursor obtained by the production process according to any one of <6> to <14>, and
<16> a cylindrical printing plate made by the making process according to <15>.

### BRIEF DESCRIPTION OF DRAWINGS

FIG. 1 A partially enlarged view of a cross-section in the circumferential direction in the vicinity of an overlap margin part of one example of the cylindrical printing plate precursor of the present invention.

FIG. 2 A partially enlarged view of a cross-section in the circumferential direction in the vicinity of an overlap margin part of another example of the cylindrical printing plate precursor of the present invention.

FIG. 3 A partially enlarged view of a cross-section in the circumferential direction in the vicinity of an overlap margin part of yet other examples of the cylindrical printing plate precursor of the present invention.

FIG. 4 A partially enlarged view from the engraving face side in the vicinity of an overlap margin part in examples of the overlap margin part before forming a joining part.

FIG. 5 A partially enlarged view from the engraving face side of part of an overlap margin part in yet another example of the cylindrical printing plate precursor of the present invention.

FIG. 6 A partially enlarged view from the engraving face side of part of an overlap margin part in yet another example of the cylindrical printing plate precursor of the present invention.

FIG. 7 A partially enlarged view from the engraving face side in the vicinity of an overlap margin part in yet another example of the cylindrical printing plate precursor of the present invention.

FIG. 8 A partially enlarged view from the engraving face side in the vicinity of an overlap margin part in yet another example of the cylindrical printing plate precursor of the present invention.

FIG. 9 A partially enlarged view from the engraving face side in the vicinity of an overlap margin part in yet another example of the cylindrical printing plate precursor of the present invention.

FIG. 10 A partially enlarged view from the engraving face side in the vicinity of an overlap margin part in yet another example of the cylindrical printing plate precursor of the present invention.

FIG. 11 A partially enlarged view from the engraving face side in the vicinity of an overlap margin part in yet another example of the cylindrical printing plate precursor of the present invention.

FIG. 12 A partially enlarged view of a cross-section showing a thickness L1 of a joining part and a thickness L2 in an overlap margin part other than the joining part, in one example of the cylindrical printing plate precursor of the present invention shown in FIG. 1.

### MODES FOR CARRYING OUT THE INVENTION

The present invention is explained in detail below.

In the present specification, the notation ‘xx to yy’ means a numerical range that includes xx and yy.

In the present invention, ‘(meth)acrylate’ means any one or both of ‘acrylate’ and ‘methacrylate’.

Furthermore, ‘mass %’ and ‘wt %’ have the same meaning, and ‘parts by mass’ and ‘parts by weight’ have the same meaning.

In the present invention, a combination of preferred embodiments explained below is a more preferred embodiment.

### (Cylindrical Printing Plate Precursor)

The cylindrical printing plate precursor of the present invention is one formed from a cured resin sheet into a cylindrical shape, the cylindrical printing plate precursor comprising an overlap margin part comprising opposite end parts of the cured resin sheet superimposed on one another, each end part of the cured resin sheet in the overlap margin part having a thickness that is smaller than the thickness of the cured resin sheet other than in the overlap margin part, and a joining part, in the overlap margin part, in which a hole providing communication between the opposite end parts of the cured resin sheet is filled with a cured resin, the overlap margin part having a width of least 5 mm but no greater than 25 mm, the joining part having a size of at least 1 mm but no greater than 3 mm, and the joining part having a cross-sectional area in the plate surface direction of at last 5% but less than 80% relative to the cross-sectional area in the plate surface direction of the overlap margin part.

The cylindrical printing plate precursor of the present invention may suitably be used as a cylindrical printing plate precursor for laser engraving.

Furthermore, the cylindrical printing plate precursor of the present invention is preferably produced by the process for producing a cylindrical printing plate precursor of the present invention, which is described later.

In the cylindrical printing plate precursor of the present invention, the width of the overlap margin part is at least 5 mm but no greater than 25 mm, preferably at least 5 mm but no greater than 20 mm, more preferably at least 5 mm but no greater than 15 mm, and particularly preferably at least 5 mm but no greater than 10 mm. When in this range, the joining strength and the thickness precision of the cylindrical printing plate precursor are excellent. Furthermore, when the overlap margin part has a width of less than 5 mm, sufficient joining strength cannot be obtained, and when it exceeds 25 mm, the thickness precision and the positional precision become poor.

In the cylindrical printing plate precursor of the present invention, the size of the joining part is at least 1 mm but no greater than 3 mm, preferably at least 1 mm but no greater 2.5 mm, more preferably at least 1 mm but no greater than 2.2 mm, and particularly preferably at least 1.5 mm but no greater than 2.2 mm. When in this range, the cylindrical printing plate precursor is excellent in terms of thickness precision and positional precision. Furthermore, when the joining part has a size of less than 1 mm, sufficient thickness precision cannot be obtained, and when it exceeds 3 mm, the thickness precision and the positional precision become poor. The ‘size of the joining part’ referred to in the present invention is the size (diameter) of a circle equivalent to the cross-sectional area in the plate surface direction of the joining part on the plate face of the cylindrical printing plate precursor of the present invention.

In the cylindrical printing plate precursor of the present invention, the cross-sectional area in the plate surface direction of the joining part is at least 5% but less than 80% relative to the cross-sectional area in the plate surface direction of the overlap margin part, preferably at least 5% but no greater than 40%, and more preferably at least 5% but no greater than 10%. When in this range, the cylindrical printing plate precursor is excellent in terms of adhesive strength and thickness precision. Furthermore, when the cross-sectional area in the plate surface direction of the joining part is less than 5% of the cross-sectional area in the plate surface direction of the overlap margin part, sufficient adhesive strength cannot be obtained, and when it is 80% or greater, the joining strength, the thickness precision, and the positional precision become poor.

When there are two or more joining parts, the cross-sectional area (area B) in the plate surface direction of the joining part is the sum total of cross-sectional areas in the plate surface direction of the two or more joining parts.

The cross-sectional area (area A) in the plate surface direction of the overlap margin part is the cross-sectional area of the entire overlap margin part including the joining part. The cross-sectional area in the plate surface direction referred to here is the cross-sectional area when sectioning is carried out through a plane parallel to the plate surface.

The cylindrical printing plate precursor of the present invention is one obtained by forming a cured resin sheet into a cylindrical shape, and comprises an overlap margin part in which opposite end parts of the cured resin sheet are superimposed on one another, the thickness of each end part of the cured resin sheet in the overlap margin part being smaller than the thickness of the cured resin sheet other than in the overlap margin part.

The shape of the opposite end parts of the cured resin sheet in the overlap margin part is not particularly limited, but it is preferable for the difference between the thickness of the overlap margin part, in which the opposite end parts are superimposed on one another, and the thickness of the cured resin sheet other than in the overlap margin part to be small, and it is more preferable for the difference to be no greater than 50 μm.

In addition, either one of the opposite end parts of the cured resin sheet is also called a start end part, and the other is called a finish end part.

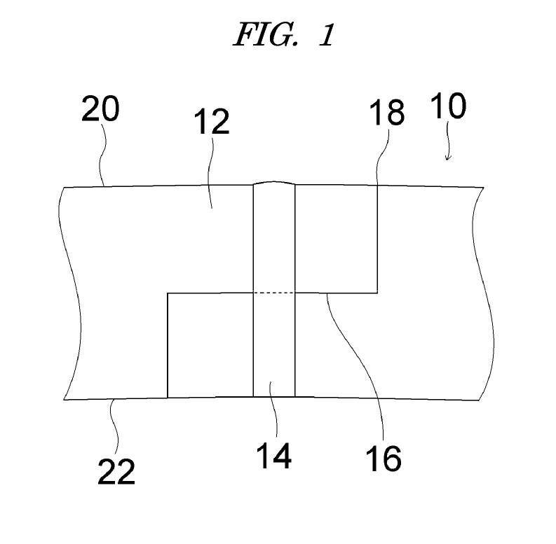

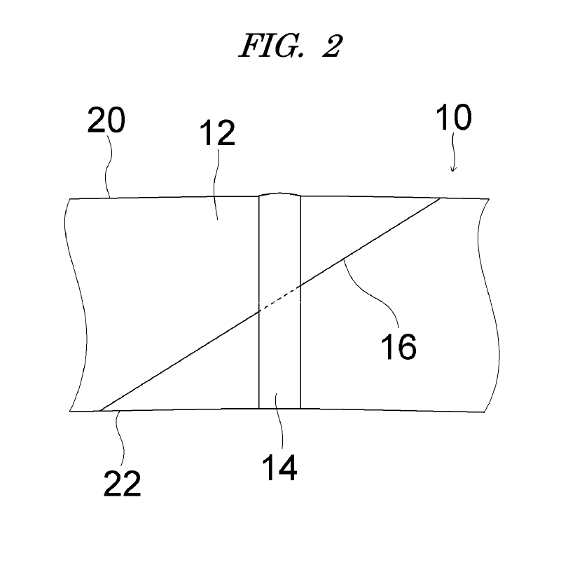

As the shape of the opposite end parts of the cured resin sheet, the shapes shown in FIG. 1 and FIG. 2 can be cited as examples, and the shape shown in FIG. 1 can be cited as a preferred example.

FIG. 1 is a partially enlarged view of a cross-section in the circumferential direction in the vicinity of an overlap margin part of one example of the cylindrical printing plate precursor of the present invention.

A cylindrical printing plate precursor 10 shown in FIG. 1 is one obtained by forming a cured resin sheet into a cylindrical shape, and comprises an overlap margin part 12 and a joining part 14, two end parts 16 (cut face) of the cured resin sheet being abutted against each other without a gap to thus form the overlap margin part 12. Furthermore, the joining part 14 is formed into a columnar shape while extending from an engraving face 20 to a support face 22 of the cylindrical printing plate precursor 10. For example, when viewed from the engraving face 20 of the cylindrical printing plate precursor 10, if the cylindrical printing plate precursor 10 is not a transparent material, the joining part 14 and a start end part 18 are observed only as lines in the overlap margin part 12.

FIG. 1 shows an example in which each of the opposite ends of the cured resin sheet is removed in a rectangular parallelepiped shape from faces opposite to each other up to a middle part in the thickness direction of the sheet, the vicinity of the start end part and the vicinity of a finish end part of the cured resin sheet have a thickness that is half the thickness of the other section, and the start end part and the finish end part of the cured resin sheet are superimposed on one another to thus form an overlap margin part.

FIG. 2 is a partially enlarged view of a cross-section in the circumferential direction in the vicinity of an overlap margin part of another example of the cylindrical printing plate precursor of the present invention.

FIG. 2 is an example in which each of the opposite ends of the cured resin sheet is sectioned obliquely in the thickness direction of the sheet, and the start end part and the finish end part of the cured resin sheet are superimposed on one another to thus form an overlap margin part.

Furthermore, with regard to the shape of the opposite end parts of the cured resin sheet, which are superimposed on one another, the start end part and the finish end part may have a symmetrical shape or may have different shapes from each other, but from the viewpoint of uniformity of physical properties of the printing plate precursor and ease of production, a symmetrical shape is preferable.

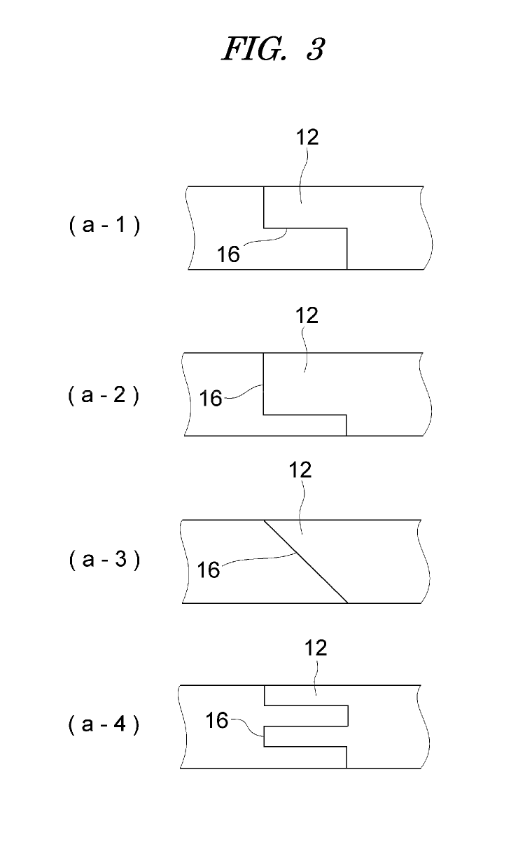

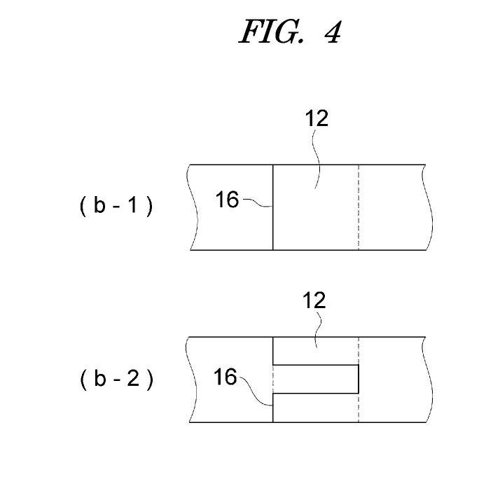

Embodiments shown in (a-2) or (a-4) in FIG. 3 and an embodiment shown in (b-2) of FIG. 4 can also be preferably cited.

(a-1) to (a-4) of FIG. 3 are partially enlarged views of cross-sections in the circumferential direction of a section in the vicinity of the overlap margin part but without a joining part of yet other examples of the cylindrical printing plate precursor of the present invention.

(a-1) of FIG. 3 is an example corresponding to the example shown in FIGS. 1, and (a-3) of FIG. 3 is an example corresponding to the example shown in FIG. 2.

(a-2) of FIG. 3 is an example in which one end part is removed in a rectangular parallelepiped shape with a larger thickness than the other end part, and the start end part and the finish end part of the cured resin sheet are superimposed on one another to thus form an overlap margin part.

(a-4) of FIG. 3 is an example in which each end part is removed in a rectangular parallelepiped shape at two positions in the thickness direction, and the start end part and the finish end part of the cured resin sheet are superimposed on one another to thus form an overlap margin part.

(b-1) and (b-2) of FIG. 4 are partially enlarged views from the engraving face side in the vicinity of the overlap margin part of one example of the cured resin sheet in which opposite end parts are superimposed on one another before forming a linking hole part and a joining part.

(b-1) of FIG. 4 is also an example corresponding to the examples shown in FIG. 1 and FIG. 2; the overlap margin part is covered by one end part from the engraving face side, and only a cut face 16 can be identified.

(b-2) of FIG. 4 is an example in which an overlap margin part is formed by fitting together one end part processed with a recessed shape and the other end part processed with a protruding shape viewed from the engraving face side. In the case of the embodiment of (b-2) of FIG. 4, it is preferable to form a joining part in a direction perpendicular to a cross-section along the circumferential direction of the cured resin sheet.

In addition, as shown in FIG. 1, the embodiment in which the thickness of the opposite end parts of the cured resin sheet changes step-wise is a particularly preferable embodiment.

The cylindrical printing plate precursor of the present invention comprises in the overlap margin part a joining part formed by filling a hole providing communication between the opposite end parts of the cured resin sheet (also called a ‘communication hole part’) with a cured resin.

The joining part is preferably a section formed by introducing a curable resin or a curable resin composition into a hole (communication hole part) providing communication between the opposite end parts of the cured resin sheet, that is, the start end part and the finish end part of the cured resin sheet, and curing it to thus fill the communication hole part therewith.

The cured resin with which the joining part is filled is not particularly limited, but it is preferably a cured resin formed by curing a composition comprising at least the same component as that of a curable resin composition used for preparation of the cured resin sheet, and is more preferably a cured resin formed by curing the same composition as the curable resin composition used for preparation of the cured resin sheet. As described above, even when the same composition as the curable resin composition used for preparation of the cured resin sheet is used for the joining part, it is possible to visually distinguish between the cured resin in the cured resin sheet and the cured resin in the joining part by means of visual examination or a microscope, etc. because of different thermal history or change in refractive index on the border.

Furthermore, the cured resin with which the joining part is filled is preferably a resin formed by curing a resin composition for laser engraving, which is described later. In accordance with this embodiment, an image can suitably be formed in the joining part by laser engraving.

The joining part and the communication hole part are not particularly limited as long as they have a shape that provides communication between the opposite end parts of the cured resin sheet, but are preferably connected to at least one face of the cured resin sheet when the overlap margin part is formed, and are more preferably connected to both faces of the cured resin sheet (the engraving face 20 and the support face 22 shown in FIG. 1).

Furthermore, the sizes, in a plane perpendicular to the thickness direction of the cured resin sheet, of the joining part and the communication hole part are preferably substantially constant. In the present invention ‘being substantially constant’ means the amount of change being within 5% of the entirety, and it is preferable for the amount of change to be within 1% of the entirety.

The shapes of the joining part and the communication hole part are not particularly limited, but are preferably of a pillar shape from the viewpoint of ease of production and joining strength, more preferably of a polyhedral shape or a columnar shape, and particularly preferably of a columnar shape. The columnar shape includes not only truly circular columnar but also elliptical columnar.

The number of joining parts is not particularly limited as long as it is at least one; it is preferably 4 to 800, more preferably 10 to 700, yet more preferably 20 to 600, particularly preferably 40 to 500, and most preferably 50 to 200. When in this range, production is easy, and the joining strength is excellent.

Moreover, a preferred size of the hole in the communication hole part is the same as the preferred size for the filled hole in the joining part, as described above.

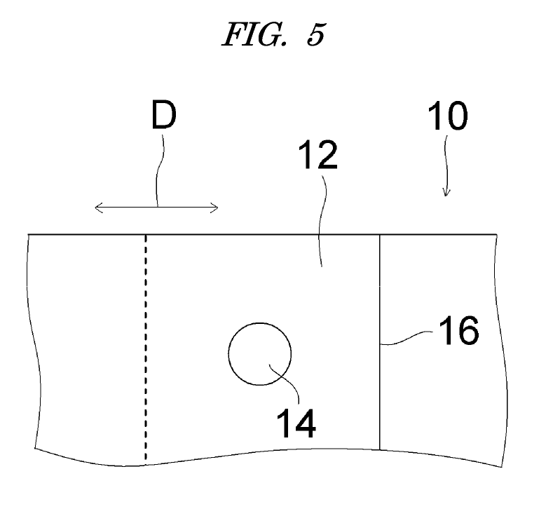

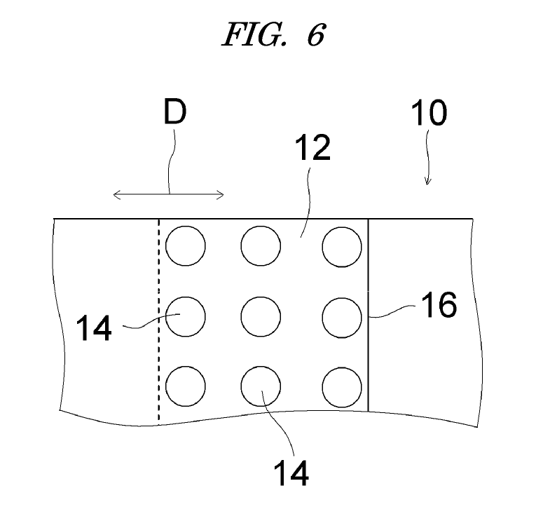

FIG. 5 and FIG. 6 are partially enlarged views from an engraving face side of part of an overlap margin part in yet another example of the cylindrical printing plate precursor of the present invention.

A cylindrical printing plate precursor 10 shown in FIG. 5 comprises an overlap margin part 12 and a joining part 14, and two end parts 16 (cut face) of a cured resin sheet are abutted against each other without a gap to thus form the overlap margin part 12. Furthermore, the joining parts 14 are each formed into a columnar shape, and a plurality thereof are formed in the same shape throughout the width direction (the up-and-down direction in the plane of the paper) of the cylindrical printing plate precursor 10.

A cylindrical printing plate precursor 10 shown in FIG. 6 comprises an overlap margin part 12 and a joining part 14, and two end parts 16 (cut face) of a cured resin sheet are abutted against each other without a gap to thus form the overlap margin part 12. Furthermore, the joining parts 14 are formed into the same columnar shape, three thereof are formed at equal intervals in a circumferential direction D (the left-and-right direction in the plane of the paper) of the cylindrical printing plate precursor 10, and a plurality thereof are formed in a row at equal intervals throughout the width direction (the up-and-down direction in the plane of the paper) of the cylindrical printing plate precursor 10.

When three or more of the joining parts are formed in the circumferential direction of the cylindrical printing plate precursor and/or the width direction of the cylindrical printing plate precursor, it is preferable for the joining parts to be formed at equal intervals in each of the directions.

Furthermore, when two or more of the joining parts are formed, the shapes of the joining parts are preferably identical.

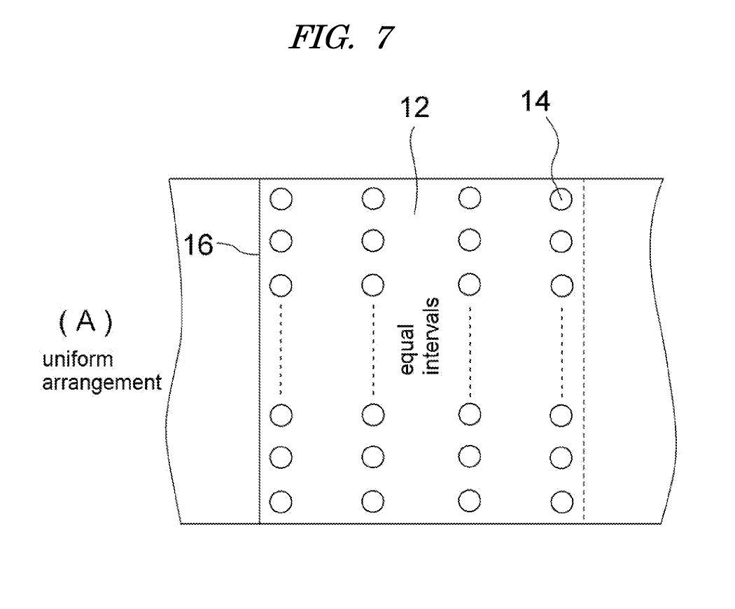

Furthermore, (A) to (E) of FIG. 7 to FIG. 11 are partially enlarged views from the engraving face side in the vicinity of the overlap margin part of yet other examples of the cylindrical printing plate precursor of the present invention.

(A) of FIG. 7 is an example (uniformly arranged example) in which columnar joining parts are formed, when viewed from the engraving face side, throughout the entire overlap margin part in four rows in the circumferential direction and n rows (n denotes any integer) in the width direction at equal intervals in the circumferential direction and the width direction.

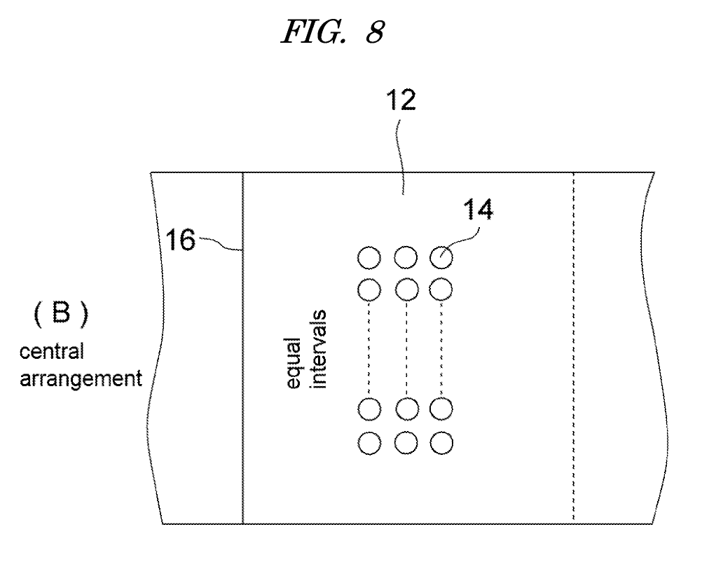

(B) of FIG. 8 is an example (centrally arranged example) in which columnar joining parts are formed, when viewed from the engraving face side, in a central part in the overlap margin part in four rows in the circumferential direction and n rows (n denotes any integer) in the width direction at equal intervals in the circumferential direction and the width direction.

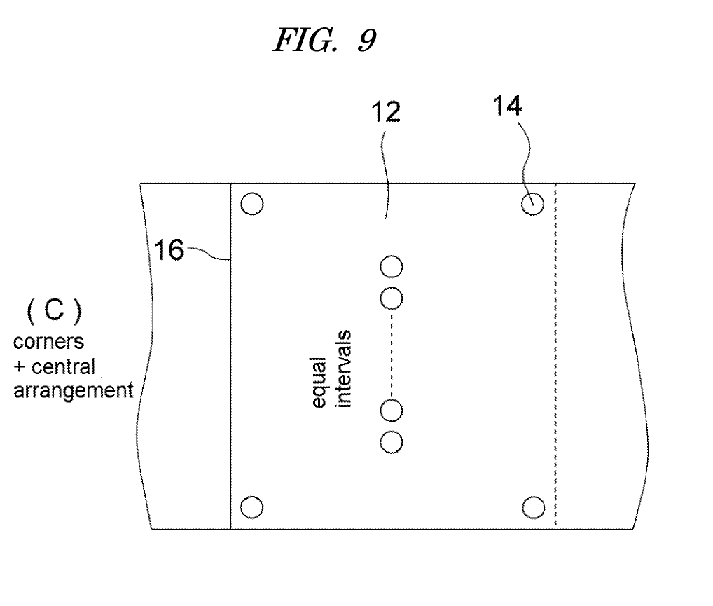

(C) of FIG. 9 is an example in which columnar joining parts are formed in each of four corners when viewed from the engraving face side of the overlap margin part and further formed, when viewed from engraving face side, in a central part of the overlap margin part in one row in the circumferential direction and n rows (n denotes any integer) in the width direction at equal intervals in the width direction.

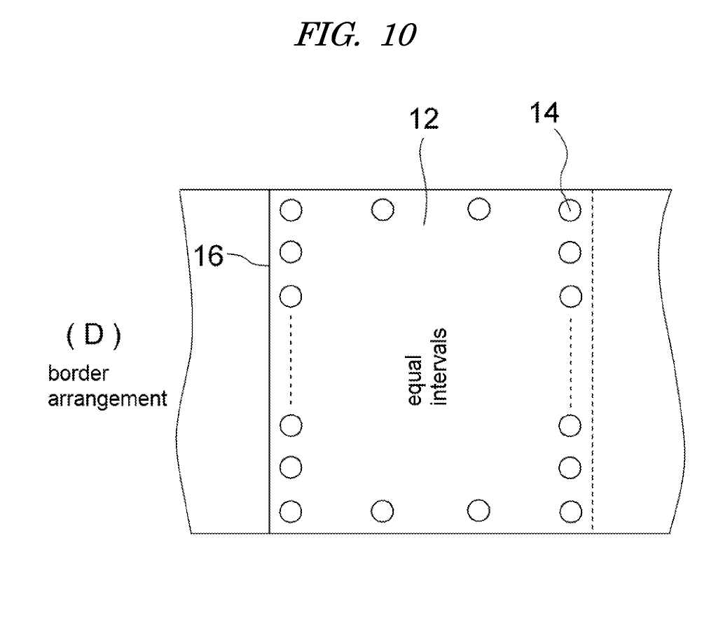

(D) of FIG. 10 is an example in which columnar joining parts are formed, when viewed from the engraving face side of the overlap margin part, in the vicinity of the four sides at equal intervals.

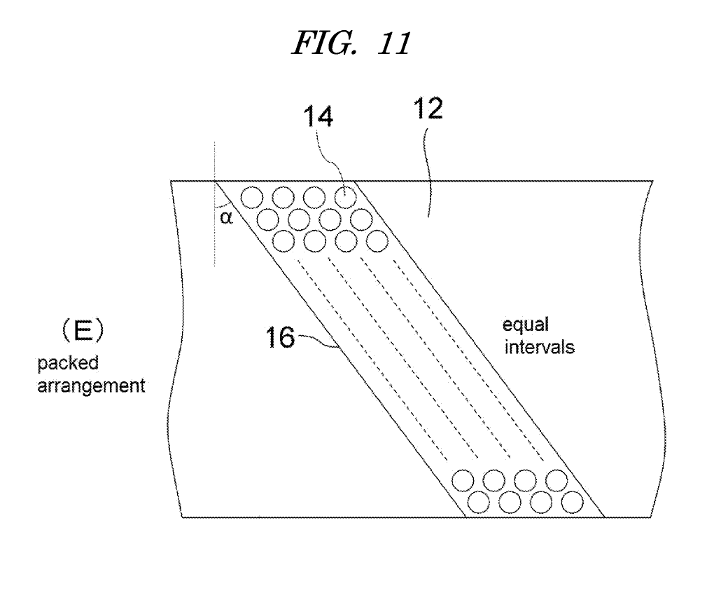

(E) of FIG. 11 is an example (packed arrangement example) in which the overlap margin part is formed obliquely at an angle α relative to the width direction, and columnar joining parts are formed, when viewed from the engraving face side, in four rows in the circumferential direction and n rows in the direction of the angle α relative to the width direction (n denotes any integer) at equal intervals in each direction. The angle α may be any value as long as it exceeds 0° and is less than 90°, but it is preferably 45° to 60°, and more preferably 60°.

Furthermore, from the viewpoint of joining strength, with regard to the cylindrical printing plate precursor of the present invention, the joining parts are formed at least in the vicinity of each of the four corners when viewed from the engraving face side or the support side of the overlap margin part. The ‘vicinity of the corner’ of the overlap margin part referred to in the present invention means a section having a distance from the corner of the overlap margin part that is no greater than 10% of the length of the diagonal line of the overlap margin part when viewed from the engraving face side or the support face side, and at least some of the joining parts are preferably present in this section in each corner.

The cylindrical printing plate precursor of the present invention comprises a sheet-form cured resin formed into a cylindrical shape. The cured resin sheet is preferably a printing plate precursor sheet comprising a layer of a cured curable resin composition.

The cured resin sheet preferably comprises a layer of a cured curable resin composition as a cured resin layer, and the curable resin composition is preferably a resin composition for laser engraving that is described later. Furthermore, the curable resin composition is preferably a thermally curable resin composition.

Moreover, the layer of the cured resin in the cured resin sheet is preferably a layer comprising a crosslinked structure, and more preferably a layer that is crosslinked by means of heat and/or light.

Preferred examples of a method for forming the cured resin sheet include, but are not particularly limited to, a method in which a curable resin composition is prepared, the solvent is removed from the curable resin composition if necessary, and it is then melt-extruded onto a substrate and a method in which a curable resin composition is cast onto a substrate, and at least part of the solvent in the curable resin composition is removed to thus form a layer, and a more preferred example includes the method in which a curable resin composition is cast onto a substrate, and at least part of the solvent in the curable resin composition is removed to thus form a layer. Furthermore, it is preferable to subsequently apply heat and/or light to the layer of the curable resin composition, thus carrying out crosslinking.

The curable resin composition may be produced by dissolving for example a crosslinking agent, a binder polymer, and as optional components a photothermal conversion agent, a fragrance, and a plasticizer in an appropriate solvent. Since it is necessary to remove most of the solvent component in a stage of producing a relief printing plate precursor, it is preferable to use as a solvent a low molecular weight alcohol (e.g. methanol, ethanol, n-propanol, isopropanol, propylene glycol monomethyl ether), etc., which is easily evaporated, and to adjust the temperature etc. so that the total amount of solvent added is as little as possible.

The thickness of the layer of cured resin in the cured resin sheet is preferably at least 0.05 mm but no greater than 20 mm, more preferably at least 0.5 mm but no greater than 10 mm, yet more preferably at least 0.5 mm but no greater than 7 mm, and particularly preferably at least 0.5 mm but no greater than 3 mm.

Furthermore, the thickness of the cured resin sheet is preferably at least 0.1 mm but no greater than 20 mm, more preferably at least 0.5 mm but no greater than 10 mm, yet more preferably at least 0.5 mm but no greater than 7 mm, and particularly preferably at least 0.5 mm but no greater than 3 mm.

Furthermore, the cured resin sheet may comprise a layer other than the layer of a cured resin; examples thereof include a known layer for the printing plate precursor to usually comprise, such as a support layer (also called simply a ‘support’), an adhesive layer, a protective layer, a slip coat layer, or a cushion layer.

The material used for the support is not particularly limited, but one having high dimensional stability is preferably used, and examples thereof include a metal such as steel, stainless steel, or aluminum, a plastic resin such as a polyester (e.g. PET (polyethylene terephthalate), PBT (polybutylene terephthalate), PAN (polyacrylonitrile)) or polyvinyl chloride, a synthetic rubber such as styrene-butadiene rubber, and a glass fiber-reinforced plastic resin (an epoxy resin, a phenolic resin, etc.). As the support, a PET film or a steel substrate is preferably used. Among them, a transparent support is preferable, and a PET film is more preferable.

The adhesive layer may be formed using a known adhesive.

The adhesive is preferably a photocurable adhesive, more preferably a photocurable adhesive comprising a (meth)acrylate compound containing a hydroxy group, a (meth)acrylate compound containing no hydroxy group, and a photopolymerization initiator, and yet more preferably a photocurable adhesive comprising only a (meth)acrylate compound containing a hydroxy group, a (meth)acrylate compound containing no hydroxy group, and a photopolymerization initiator. As the photocurable adhesive, those described in JP-A-2011-173295 may suitably be used.

Furthermore, as a material (adhesive) that can be used in the adhesive layer, for example, those described in ‘Handbook of Adhesives’, 2nd edition (1977), ed. by I. Skeist may be used.

A material for the protective layer is not particularly limited, but a material known as a protective film of a printing plate such as for example a polyester film such as PET (polyethylene terephthalate) or a polyolefin film such as PE (polyethylene) or PP (polypropylene) may be used. The surface of the film may be plain or made matte.

Furthermore, the thickness of the protective layer is preferably 25 to 500 μm, and more preferably 50 to 200 μm.

A material for the cushion layer is not particularly limited, and it may be formed using a known material. Examples include an elastic foam resin such as a sponge.

Moreover, a material used in the slip coat layer preferably comprises as a main component a resin that is soluble or dispersible and has little tackiness, such as polyvinyl alcohol, polyvinyl acetate, partially saponified polyvinyl alcohol, hydroxyalkylcellulose, alkylcellulose, or a polyamide resin.

### (Process for Producing Cylindrical Printing Plate Precursor)

The process for producing a cylindrical printing plate precursor of the present invention comprises (1) a step of preparing a cured resin sheet, (2) a step of forming a part of the cured resin sheet that becomes an overlap margin, (3) a step of forming a hole providing communication within an overlap margin part in which an overlap margin on the winding start end side of the cured resin sheet and an overlap margin on the winding finish end side are superimposed on one another, and (4) a step of forming a joining part by filling the hole with a cured curable resin composition, the overlap margin part having a width of at least 5 mm but no greater than 25 mm, the joining part having a size of at least 1 mm but no greater than 3 mm, and the hole having a cross-sectional area in the plate surface direction of at last 5% but less than 80% relative to the cross-sectional area in the plate surface direction of the overlap margin part.

‘(1) a step of preparing a cured resin sheet comprising a layer of a cured curable resin composition’, etc. is also called ‘step (1)’, etc.

The cylindrical printing plate precursor of the present invention is suitably produced by the process for producing a cylindrical printing plate precursor of the present invention.

Furthermore, preferred embodiments of the cylindrical printing plate precursor obtained by the process for producing a cylindrical printing plate precursor of the present invention are the same as preferred embodiments of the cylindrical printing plate precursor of the present invention described above.

Furthermore, with regard to the process for producing a cylindrical printing plate precursor of the present invention, it is preferable for any one of step (2) to step (4) above to be a step that is carried out while fixing at least one end part of the cured resin sheet, and it is more preferable for all of step (2) to step (4) above to be steps that are carried out while fixing at least one end part of the cured resin sheet.

### <Step (1)>

The process for producing a cylindrical printing plate precursor of the present invention comprises (1) a step of preparing a cured resin sheet.

The cured resin sheet that can be used in the process for producing a cylindrical printing plate precursor of the present invention is the same as the cured resin sheet in the cylindrical printing plate precursor of the present invention described above, and preferred embodiments are also the same.

The process for producing a cured resin sheet is not particularly limited; the production may be carried out using a known method, but it is preferable for it to comprise a step of forming a layer of a cured curable resin composition by curing a resin composition for laser engraving described later.

### <Step (2)>

The process for producing a cylindrical printing plate precursor of the present invention comprises (2) a step of forming a part of the cured resin sheet that becomes an overlap margin.

The overlap margin is preferably formed in each of both ends of the cured resin sheet.

It is preferable for the thickness of the overlap margin to be smaller than the thickness of the cured resin sheet other than in the overlap margin.

The shape of the overlap margin is not particularly limited; for example, the start end part and the finish end part may have a symmetrical shape or may have different shapes from each other, but from the viewpoint of uniformity of physical properties of the printing plate precursor and ease of production, a symmetrical shape is preferable.

Furthermore, when an overlap margin part is formed by superimposing an overlap margin formed in the start end part of the cured resin sheet and an overlap margin formed in the finish end part of the cured resin sheet, it is preferable for the difference between the thickness of the overlap margin part and the thickness of the cured resin sheet other than in the overlap margin part to be small, and it is more preferable for the difference to be no greater than 50 μm.

A method for forming the overlap margin is not particularly limited; a known method for processing a resin may be used, and a known method for processing a rubber may preferably be used.

Preferred specific examples include water jet, molding, milling machining, extrusion molding, lathe processing, drilling, plotter cutting, stamping using a Thompson die, and spinning.

### <Step (3)>

The process for producing a cylindrical printing plate precursor of the present invention comprises (3) a step of forming a hole providing communication within an overlap margin part in which an overlap margin on the winding start end side of the cured resin sheet and an overlap margin on the winding finish end side are superimposed on one another.

The winding start end of the cured resin sheet is either one of opposite end parts of the cured resin sheet, and the winding finish end is the other end part.

An embodiment of the hole providing communication within the overlap margin part in the process for producing a cylindrical printing plate precursor of the present invention is the same as the embodiment of the joining part and the linking hole part in the cylindrical printing plate precursor of the present invention, and preferred embodiments are also the same.

The hole formed in step (3) is preferably a through hole that extends through two of the overlap margins.

As a method for forming a hole providing communication within the overlap margin part, a hole may be formed in a state in which two overlap margins are superimposed on one another, or a hole may be formed in each of the overlap margins, and the overlap margins with a hole formed therein are then superimposed on one another, but from the viewpoint of ease of production and positional precision it is preferable to form a hole in a state in which two overlap margins are superimposed on one another.

Furthermore, a method for forming the hole is not particularly limited; a known method for processing a resin may be used, and a known method for processing a rubber may preferably be used.

Among them, it is preferable to form a hole by NC (numerical control) processing, and it is more preferable to form a hole by CNC (computerized NC) processing.

NC processing is a method in which control of a processing machine is carried out using numerical information, and the position of a tool, the route, rotation of a main shaft, and the position of a workpiece are controlled by programming. In the past, numerical input was carried out using a magnetic tape or paper on which data for control had been recorded, but due to the development of computers it is now possible to carry out control by direct numerical input into a display mounted on a machine. This case is sometimes specifically called CNC, but those now called NC processing denote CNC processing in most cases.

Furthermore, as a method for forming the hole, it is particularly preferable to carry out milling machining using NC. With regard to this embodiment, it is easy to form a columnar hole, and even when a large number of holes are formed, it is possible to easily form a hole at a desired precise position.

### <Step (4)>

The process for producing a cylindrical printing plate precursor of the present invention comprises (4) a step of forming a joining part by filling the hole with a cured curable resin composition.

In step (4), a curable resin composition may be poured into the hole and the curable resin composition may be cured in the hole, or an already cured curable resin composition may be inserted into the hole, but from the viewpoint of joining strength and thickness precision it is preferable to pour a curable resin composition into the hole and cure the curable resin composition in the hole.

The curable resin composition in step (4) is not particularly limited, but is preferably a composition comprising at least the same component as a curable resin composition used in preparation of the cured resin sheet, and is more preferably the same composition as the curable resin composition used in preparation of the cured resin sheet.

Furthermore, the curable resin composition in step (4) is preferably a resin composition for laser engraving that is described later.

Since the joining part is preferably flat on the cylindrical printing plate precursor surface, it is preferable for there to be, after the step of pouring a curable resin composition into the hole, a step of leveling the surface. A method for leveling the surface is not particularly limited, but a known method may be used. Examples include a method in which leveling is carried out using a spatula, etc. and a method in which the surface is pressed by means of a substrate, a support, etc.

A method for curing the curable resin composition in the hole is not particularly limited, and the curing method may be selected according to the constitution of the curable resin composition; preferred examples include a method involving curing by the application of light and/or heat, and more preferred examples include a method involving curing by the application of heat. The application of heat may be carried out only in the vicinity of the hole or may be carried out for the entire cylindrical printing plate precursor.

The wavelength and the amount of exposure of light applied and the temperature and the time of heat applied may be selected as appropriate according to the curable resin composition that is used.

Furthermore, in step (4) it is preferable to fix the cured resin sheet into a cylindrical shape so that the positions of the holes in the overlap margins are not displaced.

A method for fixing the cured resin sheet into a cylindrical shape is not particularly limited, and a known method may be employed for fixation, but it is preferable to carry out a step of fixing it to a cylindrical support such as a print sleeve (plate cylinder) by means of an adhesive, etc. before a step of pouring a curable resin composition into the hole.

Furthermore, step (4) preferably comprises a step of pouring an uncured curable resin composition into the hole and a step of curing the uncured curable resin composition, more preferably comprises a step of pouring an uncured curable resin composition into the hole, a step of leveling the surface of the poured curable resin composition, and a step of curing the uncured curable resin composition, and yet more preferably comprises a step of fixing to a cylindrical support a cured resin sheet having a hole formed therein, a step of pouring an uncured curable resin composition into the hole, a step of leveling the surface of the poured curable resin composition, and a step of curing the uncured curable resin composition.

Furthermore, the process for producing a cylindrical printing plate precursor of the present invention may comprise a known step other than step (1) to step (4) above.

Examples include a step of fixing the cured resin sheet having the hole formed therein to a cylindrical support such as a print sleeve (plate cylinder), as described above.

### <Resin Composition for Laser Engraving>

The cured resin sheet in the cylindrical printing plate precursor of the present invention preferably comprises a layer formed by curing a resin composition for laser engraving, which is described below.

Furthermore, the curable resin composition in the process for producing a cylindrical printing plate precursor of the present invention is preferably the resin composition for laser engraving described below, and the printing plate precursor sheet preferably comprises a layer formed by curing the resin composition for laser engraving described below.

Moreover, a layer formed by curing the resin composition for laser engraving is a layer that can be laser-engraved and is also called a ‘recording layer’ in the present invention.

The resin composition for laser engraving (hereinafter, also simply called a ‘resin composition’) that can be used in the present invention preferably comprises a binder polymer, more preferably comprises a binder polymer and a photothermal conversion agent, yet more preferably comprises a binder polymer, a photothermal conversion agent, and a crosslinking agent, and particularly preferably comprises a binder polymer, a photothermal conversion agent, and a reactive silane compound.

Specific examples of the mode of application of the resin composition include, but are not limited to, an image formation layer of an image formation material for which image formation is carried out by laser engraving, and a recording layer of a printing plate precursor, an intaglio plate, a letterpress plate, and a stamp for which formation of a raised relief is carried out by laser engraving. The constituent elements of the resin composition for laser engraving are explained below.

### (Crosslinking Agent)

From the viewpoint of forming a crosslinked structure in a recording layer, the resin composition for laser engraving preferably contains a crosslinking in order to form this crosslinked structure.

In regard to the crosslinking agent that can be used in the present invention, any crosslinking agent can be used without particular limitations as long as it can be converted to a polymer by a light- or heat-induced chemical reaction and be cured. Particularly, a polymerizable compound having an ethylenically unsaturated group (hereinafter, also referred to as “polymerizable compound”), a reactive silane compound having a reactive silyl group such as an alkoxysilyl group or a halogenated silyl group, a reactive titanium compound, a reactive aluminum compound, or the like is preferably used, and a reactive silane compound is more preferably used. These compounds may form a crosslinked structure within the recording layer by reacting with the binder, or may form a crosslinked structure by reacting with other polymerizable compounds. The polymerizable compounds may also form a crosslinked structure through both the reactions.

The polymerizable compound that can be used herein can be arbitrarily selected among compounds having at least one ethylenically unsaturated group, preferably two or more ethylenically unsaturated groups, and more preferably 2 to 6 ethylenically unsaturated groups.

The resin composition for laser engraving preferably contains a compound having a group represented by following Formula (I) (hereinafter, also referred to as “Compound (I)”).

-M(R¹)(R²)ₙ (I)

wherein in Formula (I), R¹ represents OR³ or a halogen atom; M represents Si, Ti or Al; when M is Si, n represents 2; when M is Ti, n represents 2; when M is Al, n represents 1; n units of R²s each independently represent a hydrocarbon group, OR³ or a halogen atom; and R³ represents a hydrogen atom or a hydrocarbon group.

In Formula (I), M represents Si, Ti or Al. Among these, M is preferably Si or Ti, and more preferably Si.

In Formula (I), R¹ represents OR³ or a halogen atom, and R³ represents a hydrogen atom or a hydrocarbon group. Examples of the hydrocarbon group include an alkyl group having 1 to 30 carbon atoms, an aryl group having 6 to 30 carbon atoms, an alkenyl group having 2 to 30 carbon atoms, and an aralkyl group having 7 to 37 carbon atoms. Among these, R³ is preferably a hydrogen atom, an alkyl group having 1 to 12 carbon atoms, or an aryl group having 6 to 20 carbon atoms; more preferably a hydrogen atom, an alkyl group having 1 to 5 carbon atoms, or an aryl group having 6 to 10 carbon atoms; and particularly preferably a methyl group or an ethyl group. That is, R¹ is particularly preferably a methoxy group or an ethoxy group.

R¹ is preferably a group capable of ionizing to -M(R²)ₙO⁻ when treated with an alkaline rinsing liquid.

In Formula (I), R² represents a hydrocarbon group, OR³ or a halogen atom. R³ has the same meaning as described above, and also has the same preferred range.

R² is preferably OR³ or a halogen atom, and more preferably OR³.

When M is Si, n is 2. When M is Si, R²s that are present in a plural number may be respectively identical or different, and are not particularly limited.

Furthermore, when M is Ti, n is 2. When M is Ti, R²s that are present in a plural number may be respectively identical or different, and are not particularly limited.

When M is Al, n represents 1.

Compound (I) described above may be a compound which introduces a group represented by Formula (I) into a polymer through a reaction with the polymer, or may also be a compound which has a group represented by Formula (I) from before the reaction, and introduces the group represented by Formula (I) to the polymer.

Compound (I) described above is particularly preferably such that M is Si.

The recording layer preferably has a siloxane bond.

When M is Si, a silane coupling agent can also be used as the compound having a group represented by Formula (I) (Compound (I)). Meanwhile, the silane coupling agent is a compound which has a group capable of reacting with an inorganic compound, such as an alkoxysilyl group, and a group capable of reacting with an organic component, such as a methacryloyl group, and can conjugate an inorganic component and an organic component. A titanium coupling agent and an aluminate-based coupling agent also have the same meanings.

It is also preferable that Compound (I) have a reactive group such as a vinyl group, an epoxy group, a methacryloyloxy group, an acryloyloxy group, a mercapto group, or an amino group, and react with a polymer by means of the reactive group, so that the group represented by Formula (I) is introduced into the polymer through this reaction.

Examples of the silane coupling agent include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(p-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-chloropropyltrimethoxysilane, and γ-ureidopropyltriethoxysilane.

As Compound (I), a compound having plural groups represented by Formula (I) is also preferably used. In this case, when a portion of the groups represented by Formula (I) reacts with a polymer, the groups represented by Formula (I) can be introduced into the polymer. For example, R¹ group and optionally R² group of compound (I) react with an atom and/or a group in the polymer, which are capable of reacting with the compound (for example, a hydroxyl group (—OH)) (for example, an alcohol exchange reaction). Furthermore, when plural groups represented by Formula (I) are bonded to the polymer, Compound (I) also functions with a crosslinking agent, and can form a crosslinked structure.

Such Compound (I) is preferably a compound having plural groups represented by Formula (I), more preferably a compound having 2 to 6 groups represented by Formula (I), and particularly preferably a compound having 2 to 3 groups represented by Formula (I).

The compounds shown below may be mentioned as preferred examples, but the present invention is not limited to these compounds.

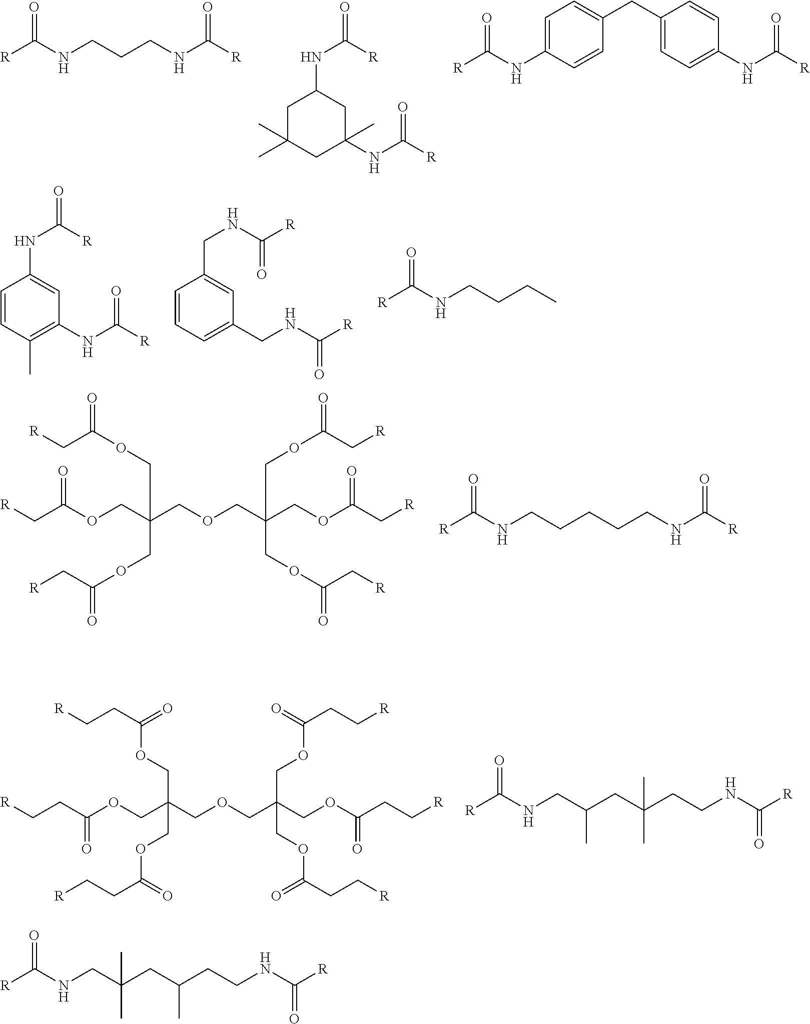

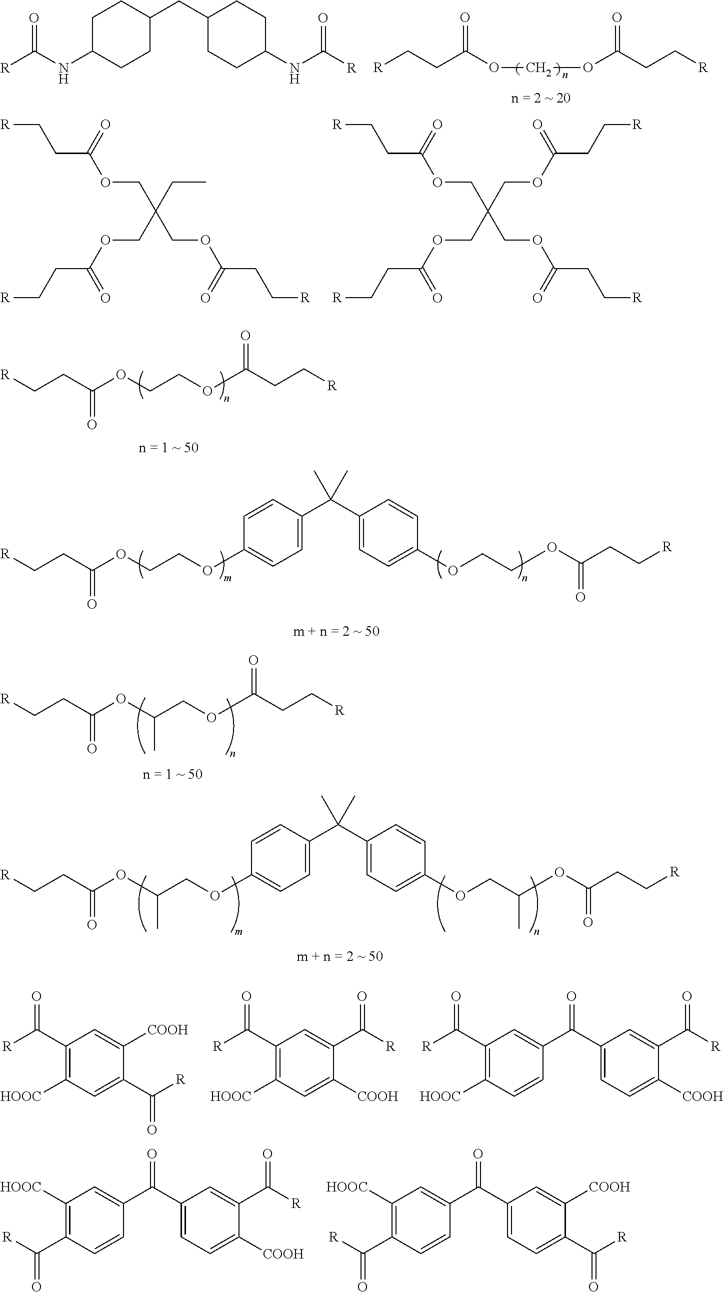

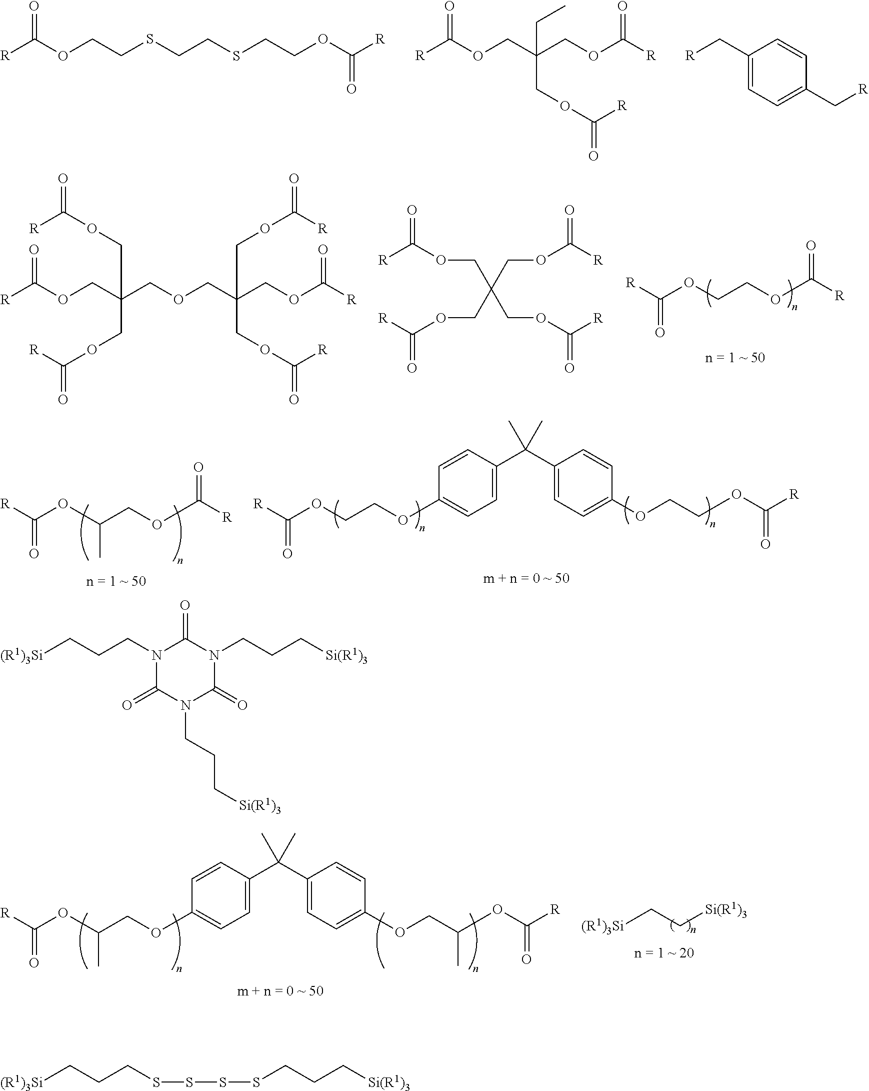

In each of the formulae above, R denotes a partial structure selected from the structures below. When a plurality of Rs and R¹s are present in the molecule, they may be identical to or different from each other, and are preferably identical to each other in terms of synthetic suitability.

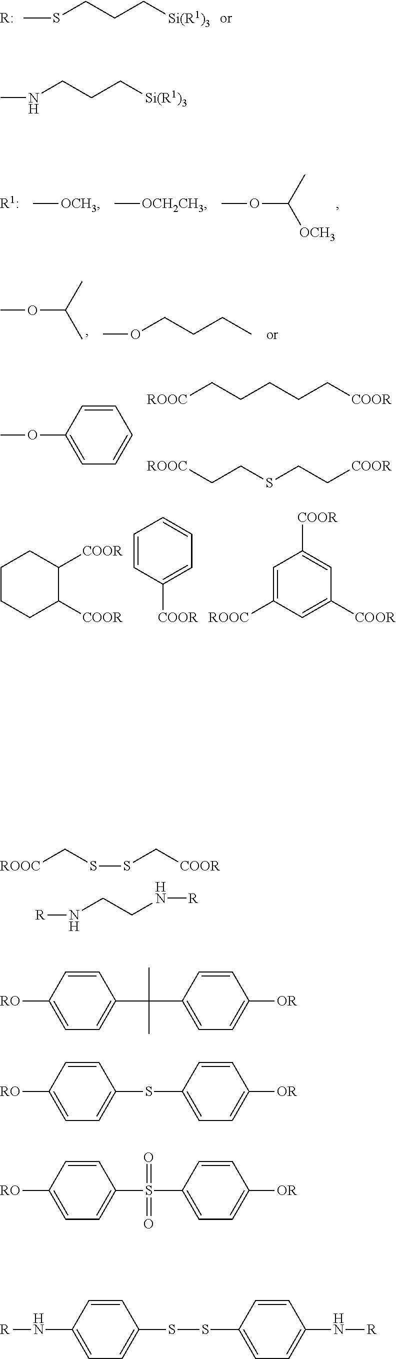

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

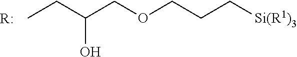

Furthermore, according to the present invention, silica particles, titanium oxide particles, aluminum oxide particles and the like can also be used as Compound (I) described above. These particles can react with a polymer that will be described below, and the group represented by Formula (I) can be introduced into the polymer. For example, when silica particles react with a polymer that will be described below, an —SiOH group is introduced.

In addition to that, examples of the titanium coupling agent include Plenact manufactured by Ajinomoto Fine Techno Co., Inc., titanium tetraisopropoxide manufactured by Matsumoto Fine Chemical Co., Ltd., and titanium-i-propoxybis(acetylacetonato)titanium manufactured by Nippon Soda Co., Ltd., and examples of the aluminate-based coupling agent include acetoalkoxy aluminum diisopropylate.

In the present invention, the compound (1) may be used only one type or two or more types in combination.

The total content of the compound (1) contained in the resin composition for laser engraving is preferably in the range of 0.1 to 80 wt % on a solids content basis, more preferably in the range of 1 to 40 wt %, and yet more preferably in the range of 5 to 30 wt %.

According to the present invention, from the viewpoint of forming a crosslinked structure in the recording layer, the resin composition for laser engraving preferably contains a polymerizable compound in order to form this structure.

The polymerizable compound that can be used herein can be selected freely among compounds having at least one ethylenically unsaturated group, preferably two or more ethylenically unsaturated groups, and more preferably 2 to 6 ethylenically unsaturated groups.

Furthermore, according to the present invention, from the viewpoint of film properties such as flexibility and brittleness in addition to the purpose of forming a crosslinked structure, a compound having only one ethylenically unsaturated group (a monofunctional polymerizable compound, a monofunctional monomer) may also be used.

Hereinafter, a compound having one ethylenically unsaturated group (a monofunctional monomer), and a compound having two or more ethylenically unsaturated groups (a polyfunctional monomer) employed as the polymerizable compound are explained.

In the thermally curable layer, polyfunctional monomers are preferably used, because the recording layer preferably has a crosslinked structure. The polyfunctional monomer has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

From the viewpoint of improving engraving sensitivity, it is preferable in the present invention to use as the polymerizable compound having an ethylenically unsaturated group a compound having a sulfur atom in the molecule.

As such an ethylenically unsaturated compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

From the viewpoint of engraving sensitivity, a mode in which a sulfur-containing polyfunctional monomer is used on its own or a mixture of a sulfur-containing polyfunctional monomer and a monofunctional ethylenic monomer is used is preferable, and a mode in which a mixture of a sulfur-containing polyfunctional monomer and a monofunctional ethylenic monomer is used is more preferable.

In the recording layer, when a polymerizable compound including a sulfur-containing polyfunctional monomer is used, the film properties, for example, brittleness and flexibility, can be adjusted.

Furthermore, the total content of the polymerizable compound including a sulfur-containing polyfunctional monomer in the resin composition is preferably 10 to 60 wt %, and more preferably 15 to 45 wt %, with respect to the non-volatile components, from the viewpoint of flexibility and brittleness of the crosslinked film.

When a polymerizable compound that is different from the sulfur-containing polyfunctional monomer is used in combination, the amount of the sulfur-containing polyfunctional monomer in the total amount of polymerizable compounds is preferably 5 wt % or more, and more preferably 10 wt % or more.

### (Binder Polymer)

The resin composition for laser engraving comprises preferably a binder polymer (hereinafter, also referred to as the “binder”).

The binder is a macromolecular component contained in the resin composition for laser engraving. Common high molecular compounds can appropriately be selected, one type thereof may be used on its own, or two or more types may be used in combination. In particular, the binder contained in the resin composition for laser engraving for use as a printing plate precursor can be selected in consideration of various performances such as laser engraving property, ink acceptance property, and engraving residue dispersibility.

The binder may be selected and used from a polystyrene resin, polyester resin, polyamide resin, polyurea resin, polyamideimide resin, polyurethane resin, polysulfone resin, polyether sulfone resin, polyimide resin, poly carbonate resin, hydroxyethylene unit-containing hydrophilic polymer, acrylic resin, acetal resin, epoxy resin, polycarbonate resin, rubber, thermoplastic elastomer, or the like.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038. Moreover, for example, when the purpose is to form a recording layer having softness and flexibility, a soft resin or a thermoplastic elastomer is selected. Such material is described in detail in JP-A-2008-163081, paragraphs 0039 to 0040. Furthermore, in a case where the resin composition for laser engraving is applied to the recording in the relief printing plate precursor for laser engraving, from the viewpoint of easy preparation of the composition for laser engraving, and the improvement of resistance properties for an oil-based ink in the obtained cylindrical printing plate, the use of a hydrophilic or alcoholphilic polymer is preferable. As the hydrophilic polymer, those described in detail in JP-A-2008-163081, paragraph 0041 can be used.

In addition, when being used for the purpose of curing by heating and exposure and improving strength, a polymer having an ethylenically unsaturated bond in the molecule is preferably used.

As such a polymer, examples of the polymer having an ethylenically unsaturated bond at the main chain include SB (polystyrene-polybutadiene), SBS (polystyrene-polybutadiene-polystyrene), SIS (polystyrene-polyisoprene-polystyrene), and SEBS (polystyrene-polyethylene/polybutylene-polystyrene).

The polymer having an ethylenically unsaturated bond at the side chain can be obtained by introducing an ethylenically unsaturated group such as an allyl group, an acryloyl group, a methacryloyl group, a styryl group, and a vinyl ether group into a structure of binder polymer below. As a method of introducing an ethylenically unsaturated group into the side chain of the binder polymer, known methods may be employed, such as (1) a method in which structural units having a polymerizable group precursor obtained by protecting a polymerizable group are copolymerized with the polymer and the protecting group is eliminated to obtain a polymerizable group and (2) a method in which a high molecular compound having a plurality of reactive group such as a hydroxy group, an amino group, an epoxy group, and a carboxyl group is prepared and a compound having a group which can react with the reactive group and an ethylenically unsaturated group is introduced by polymer reaction. According to these methods, the amount of an ethylenically unsaturated group introduced into the high molecular compound can be controlled.

As the binder, the use of a polymer having a hydroxyl group (—OH) (hereinafter, also referred to as the “specific polymer”) is particularly preferable. As the skeleton of the specific polymer, although not particularly limited, an acrylic resin, an epoxy resin, hydrophilic polymers containing a hydroxyethylene unit, a polyvinylacetal resin, a polyester resin and a polyurethane resin are preferable.

Examples of the acrylic monomers used for synthesizing an acrylic resin having a hydroxyl group include preferably (meth)acrylic acid esters, crotonic acid esters and (meth)acrylamides having a hydroxyl group in the molecule. Specific examples of such monomers include 2-hydroxyethyl (meth)acrylate, 2-hydroxypropyl (meth)acrylate, 4-hydroxybutyl (meth)acrylate etc. Copolymers obtained by copolymerizing these with a known (meth)acrylic-based monomer or vinyl-based monomer are used preferably.

As the specific polymer, the use of an epoxy resin having a hydroxyl group on the side chain may also be possible. As a preferable specific example, an epoxy resin obtained by polymerizing an adduct of bisphenol A and epichlorohydrin as raw material monomers is cited.

As the polyester resin, a polyester resin containing a hydroxycarboxylic acid unit such as polylactic acid is preferably used. Specifically, the polyester resin selected from the group consisting of polyhydroxy alkanoate (PHA), lactic acid-based polymer, polyglycolic acid (PGA), polycaprolactone (PCL), poly(butylenesuccinic acid), derivatives and mixtures thereof is preferable.

As the specific polymer, a polymer having an atom and/or a group capable of reacting with the above-mentioned compound (I) is preferable, and a binder polymer that has an atom and/or a group capable of reacting with the compound (I) and is insoluble in water and soluble in an alcohol having 1 to 4 carbon atoms is more preferable.

Examples of the atom and/or the group capable of reacting with the compound (I) include, although not particularly limited, an ethylenically unsaturated bond, an epoxy group, an amino group, a (meth)acryloyl group, a mercapto group and a hydroxyl group, and, among these, a hydroxyl group is exemplified preferably.

Examples of preferable specific polymers in the present invention include polyvinyl butyral (PVB), acrylic resin having a hydroxyl group on the side chain, epoxy resin having a hydroxyl group on the side chain etc., from the viewpoint of having high engraving sensitivity and good film performance while satisfying both the aptitude for an aqueous ink and the aptitude for a UV ink.

The specific polymer usable for the present invention gives particularly preferably a glass transition temperature (Tg) of at least 20° C., when combined with a photothermal conversion agent capable of absorbing light having a wavelength of 700 to 1,300 nm to be described later, which is a preferable combining component of the resin composition for laser engraving constituting the recording layer in the present invention, because the engraving sensitivity is improved. Hereinafter, the polymer having such glass transition temperature is referred to as a non-elastomer. That is, the elastomer is generally defined scientifically as a polymer having a glass transition temperature that is no greater than normal temperature (20° C.) (see Kagaku Daijiten (comprehensive dictionary of science), P154, second edition, edited by Foundation for Advancement of International Science, published by Maruzen Co., Ltd.). Accordingly, the non-elastomer denotes polymers having a glass transition temperature that is greater than ordinary temperature. Although the upper limit of the glass transition temperature of the specific polymer is not particularly limited, it is preferably no greater than 200° C. from the viewpoint of handling properties, and more preferably at least 25° C. but no greater than 120° C.

When a polymer having a glass transition temperature of room temperature (20° C.) or greater is used, the specific polymer is in a glass state at normal temperature. Because of this, compared with a case of the rubber state, thermal molecular motion is suppressed. In laser engraving, in addition to the heat given by a laser during laser irradiation, heat generated by the function of a photothermal conversion agent added as desired is transmitted to the surrounding specific polymer, and this polymer is thermally decomposed and disappears, thereby forming an engraved recess.

When the specific polymer is used, it is surmised that when a photothermal conversion agent is present in a state in which thermal molecular motion of the specific polymer is suppressed, heat transfer to and thermal decomposition of the specific polymer occur effectively. It is anticipated that such an effect further increases the engraving sensitivity.

Examples of the binder that can be preferably used in the present invention are shown below.

### (1) Polyvinyl Acetal and Derivative Thereof

Polyvinyl acetal is a compound obtained by converting polyvinyl alcohol (obtained by saponifying polyvinyl acetate) into a cyclic acetal. A polyvinyl acetal derivative is a polymer that polyvinyl acetal is modified, or a polyvinyl acetal having another copolymerization component.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerization unit.

Examples of the polyvinyl acetal include polyvinyl butyral, polyvinyl propylal, polyvinyl ethylal, and polyvinyl methylal. Among them, polyvinyl butyral (PVB) is preferable.

Polyvinyl butyral is a polymer obtained by a reaction polyvinyl alcohol and butyl aldehyde. A polyvinyl butyral derivative may be used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, and a modified PVB in which at least some of the hydroxy groups have introduced thereinto ethylene glycol, propylene glycol, or a multimer thereof.

From the viewpoint of a balance being achieved between engraving sensitivity and film formation properties, the molecular weight of the polyvinyl acetal is preferably 5,000 to 800,000 as the weight-average molecular weight, more preferably 8,000 to 500,000 and, from the viewpoint of improvement of rinsing properties for engraving residue, particularly preferably 50,000 to 300,000.

Particularly preferable examples of the polyvinyl acetal are explained below by polyvinyl butyral (PVB) and the derivatives thereof, but the polyvinyl acetal should not be construed as being limited to the Examples.

Polyvinyl butyral derivatives are commercially available and preferable examples from viewpoint of solubility in alcohol, particularly in ethanol, are the ‘E-LEC B’ series and the ‘E-LEC K (KS)’ series manufactured by Sekisui Chemical co., Ltd., the Denka Butyral series manufactured by Denki Kagaku Kogyo Kabushiki Kaisha. From the viewpoint of alcohol solubility (particularly in ethanol), the ‘S-LEC B’ series manufactured by Sekisui Chemical Co., Ltd. and ‘Denka Butyral’ manufactured by Denki Kagaku Kogyo Kabushiki Kaisha are more preferable; among the ‘S-LEC B’ series, ‘BL-1’, ‘BL-1H’, ‘BL-2’, ‘BL-5’, ‘BL-S’, ‘BX-L’, ‘BM-S’, and ‘BH-S’ are particularly preferable, and among the ‘Denka Butyral’ manufactured by Denki Kagaku Kogyo Kabushiki Kaisha ‘#3000-1’, ‘#3000-2’, ‘#3000-4’, ‘#4000-2’, ‘#6000-C’, ‘#6000-EP’, ‘#6000-CS’, and ‘#6000-AS’ are particularly preferable.

When manufacturing a recording layer from PVB as the specific polymer, casting and drying of a solution in a solvent is preferable from viewpoint of flatness of the film surface.

In addition to the polyvinylacetal and derivatives thereof, as the specific polymer, it is also possible to use an acrylic resin that is obtained by using a known acrylic monomer and has a hydroxyl group in a molecule. Furthermore, as the specific polymer, a novolac resin that is a resin obtained by condensing phenols and aldehydes under an acidic condition may also be used. Moreover, as the specific polymer, an epoxy resin having a hydroxyl group on a side chain may also be used.

Among the specific polymers, polyvinyl butyral and derivatives thereof are particularly preferable from the viewpoint of rinsing properties and printing durability when made into a recording layer.

The content of a hydroxyl group contained in the specific polymer in the present invention is preferably 0.1 to 15 mmol/g, and more preferably 0.5 to 7 mmol/g, in the polymer of any embodiment described above.

With regard to the binder in the resin composition, only one type may be used or two or more types may be used in combination.

The weight average molecular weight of the binder that can be used in the present invention (on a polystyrene basis by GPC measurement) is preferably 5,000 to 1,000,000, more preferably 8,000 to 750,000, and most preferably 10,000 to 500,000.

From the viewpoint of satisfying the shape retention, water resistance and engraving sensitivity of the coated film in a balanced manner, the content of the specific polymer in the resin composition employable in the present invention is, in the total solids content, preferably 2 to 95 wt %, more preferably 5 to 80 wt %, and particularly preferably 10 to 60 wt %.

The content of the binder polymer is preferably 5 to 95 wt % relative to a solids content basis total weight of the resin composition for laser engraving, more preferably 15 to 80 wt %, and yet more preferably 20 to 65 wt %.

For example, when the resin composition for laser engraving of the present invention is applied to the recording layer of the relief printing plate precursor, setting the content of the binder polymer to at least 5 wt % gives printing durability that is sufficient for the relief printing plate so obtained to be used as a printing plate, and setting it to no greater than 95 wt % gives flexibility that is sufficient for the relief printing plate so obtained to be used as a flexographic printing plate, without making other components insufficient.

### Solvent

The resin composition for laser engraving that can be used in the present invention preferably contains a solvent in order to easily form a recording layer.

According to the present invention, for the solvent used to prepare the resin composition, it is preferable to use mainly an aprotic organic solvent from the viewpoint of rapidly carrying out a reaction between Compound (I) and a specific polymer. More specifically, it is preferable to use an aprotic organic solvent/protic organic solvent=100/0 to 50/50 (weight ratio). The weight ratio is more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methly isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

### Alcohol Exchange Reaction Catalyst

The resin composition preferably comprises an alcohol exchange reaction catalyst in order to promote reaction the compound (1) and the specific binder polymer, in using the compound (1) for the resin composition.

With regard to the alcohol exchange reaction catalyst, any reaction catalyst that is usually used in a silane coupling reaction may be used without any limitation.

An acidic catalyst, a basic catalyst, and a metal complex catalyst, which are representative alcohol exchange reaction catalysts, are individually explained below.

### “An Acidic or a Basic Catalyst”

As the catalyst, an acidic or basic catalyst is used as it is or in the form of a solution in which it is dissolved in a solvent such as water or an organic solvent. The concentration when dissolved in a solvent is not particularly limited, and it may be selected appropriately according to the properties of the acidic or basic compound used, desired catalyst content, etc.

The type of the alcohol exchange reaction catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid etc, and examples of the basic catalyst include an ammoniacal base such as aqueous ammonia, an amine such as ethyl amine and aniline etc. Among these, from the viewpoint of progressing fastly an alcohol exchange reaction in the layer, methanesulfonic acid, p-toluenesulfonic acid, pyridinium-p-toluene sulfonate, phosphoric acid, phosphonic acid and acetic acid are preferable, and methanesulfonic acid, p-toluenesulfonic acid and phosphoric acid are particularly preferable.

### “Metal Complex Catalyst”

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, ethyl orthotitanate, etc. is more preferable.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition of the present invention may employ only one type of an alcohol exchange reaction catalyst or two or more types thereof in combination.

The content of the alcohol exchange reaction catalyst in the resin composition is preferably 0.01 to 20 weight % in the content of the polymer having a hydroxy group, and more preferably 0.1 to 10 weight %.

### Polymerization Initiator

The resin composition for laser engraving that can be used in the present invention preferably comprises a polymerization initiator, and more preferably comprises a polyfunctional ethylenically unsaturated compound and a polymerization initiator in order to promote formation of the crosslinked structure.

With regard to the polymerization initiator, one known to a person skilled in the art may be used without any limitations. Radical polymerization initiators, which are preferred polymerization initiators, are explained in detail below, but the present invention should not be construed as being limited to these descriptions.

Polymerization initiators can be roughly divided into photopolymerization initiators and thermopolymerization initiators.

As the photopolymerization initiator, those described above is preferably used.

In the present invention, from the viewpoint of increasing the degree of crosslinking, a thermopolymerization initiator is preferably used.

As the thermopolymerization initiator, an organic peroxide (c) and an azo-based compound (I) are preferably used. The compounds shown below are particularly preferable.

### (c) Organic Peroxide

Preferable examples of the organic peroxide (c) as the radical polymerization initiator that can be used in the present invention include prederably ether peoxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate, t-butylperoxybenzoate etc.

### (I) Azo-Based Compound

Preferred examples of the azo-based compound (I) that can be used in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

With regard to the polymerization initiator in the present invention, one type may be used on its own or two or more types may be used in combination.

The content of the polymerization initiator is preferably 0.01 to 10 weight % in the total solids content of the resin composition for laser engraving, and more preferably 0.1 to 3 weight %.

### Photothermal Conversion Agent

The recording layer preferably comprises a photothermal conversion agent.

The resin composition for laser engraving preferably comprises a photothermal conversion agent.

That is, It is surmised that the photothermal conversion agent in the present invention absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the recording layer in the present invention to comprise a photothermal conversion agent that can absorb light having a wavelength of 700 to 1,300 nm.

As the photothermal conversion agent in the present invention, various types of dye or pigment are used.

The photothermal conversion agent is more preferably at least one photothermal conversion agent selected from the group consisting of a pigment and a dye having a maximum absorption wavelength at 800 to 1,200 nm.

The photothermal conversion agent is preferably a pigment.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium dyes, pyrylium salts, and metal thiolate complexes. In particular, cyanine-based dyes such as heptamethine cyanine dyes, oxonol-based dyes such as pentamethine oxonol dyes, and phthalocyanine-based dyes are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP absorption and also finely divided carbon black having a large specific surface area. Preferred examples of carbon black include Printex (registered trademark) U, Printex (registered trademark) A, and Spezialschwarz (registered trademark) 4 (Degussa).

The carbon black that can be used in the present invention is preferably a conductive carbon black having a specific surface area of at least 150 m²/g and a dibutyl phthalate (DBP) absorption number of at least 150 mL/100 g.

From the viewpoint of improving engraving sensitivity by efficiently transmitting heat generated by photothermal conversion to the surrounding polymer, etc., the carbon black is preferably a conductive carbon black having a specific surface area of at least 150 m²/g.

The content of the photothermal conversion agent in the recording layer of the relief printing plate precursor or the resin composition for laser engraving of the present invention largely depends on the size of the molecular extinction coefficient characteristic to the molecule, and is preferably 0.01 to 20 wt % relative to the total weight of the solids content of the recording layer or the resin composition, more preferably 0.05 to 10 wt %, and yet more preferably 0.1 to 5 wt %.

### Other Additives

The resin composition for laser engraving and the recording layer of the relief printing plate precursor may be comprise a known additive other than those described above.

The resin composition for laser engraving of the present invention contains preferably a plasticizer.

The plasticizer is a material having the function of softening the film formed with the resin composition for laser engraving, and has necessarily a good compatibility relative to the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material. Since nitrocellulose is a self-reactive compound, it generates heat during laser engraving, thus assisting thermal decomposition of a coexisting binder polymer such as a hydrophilic polymer. It is surmised that as a result, the engraving sensitivity improves. A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of the recording layer, a known additive such as a filler may be added.

### (Cylindrical Printing Plate and Process for Making Same)

The process for making a cylindrical printing plate of the present invention comprises a plate making step of subjecting to plate making the cylindrical printing plate precursor of the present invention or a cylindrical printing plate precursor obtained by the process for producing a cylindrical printing plate precursor of the present invention, and the plate making step is preferably an engraving step of laser-engraving the cylindrical printing plate precursor of the present invention or a cylindrical printing plate precursor obtained by the process for producing a cylindrical printing plate precursor of the present invention.

The cylindrical printing plate of the present invention is a cylindrical printing plate obtained from the cylindrical printing plate precursor of the present invention or from a cylindrical printing plate precursor obtained by the process for producing a cylindrical printing plate precursor of the present invention, and is preferably a cylindrical printing plate obtained by laser-engraving the cylindrical printing plate precursor of the present invention or a cylindrical printing plate precursor obtained by the process for producing a cylindrical printing plate precursor of the present invention.

### <Engraving Step>

With regard to the process for making a cylindrical printing plate of the present invention, the plate making step preferably comprises an engraving step of laser-engraving the cylindrical printing plate precursor of the present invention or a cylindrical printing plate precursor obtained by the process for producing a cylindrical printing plate precursor of the present invention.

The engraving step is a step of laser-engraving a recording layer of a cylindrical printing plate precursor to thus form a relief layer. Specifically, it is preferable to engrave a recording layer by irradiation with laser light according to a desired image, thus forming a relief layer. Furthermore, a step in which a recording layer is subjected to scanning irradiation by controlling a laser head using a computer in accordance with digital data of a desired image can preferably be cited.

This engraving step preferably employs an infrared laser. When irradiated with an infrared laser, molecules in the recording layer undergo molecular vibration, thus generating heat. When a high power laser such as a carbon dioxide laser or a YAG laser is used as the infrared laser, a large quantity of heat is generated in the laser-irradiated area, and molecules in the recording layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for the groove to be blocked with ink, thus enabling breakup of an outline character to be suppressed.

In particular, when engraving is carried out using an infrared laser that corresponds to the absorption wavelength of a photothermal conversion agent, it becomes possible to selectively remove the recording layer at higher sensitivity, thus giving a relief layer having a sharp image.

As the infrared laser used in the engraving step, from the viewpoint of productivity, cost, etc., a carbon dioxide laser or a semiconductor laser is preferable. In particular, a fiber-coupled semiconductor infrared laser is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is future preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a cylindrical printing plate employing the cylindrical printing plate precursor of the present invention, those described in detail in JP-A-2009-172658 and JP-A-2009-214334 can be cited. Such equipment comprising a fiber-coupled semiconductor laser can be used to produce a cylindrical printing plate of the present invention.

The process for producing a cylindrical printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved recording layer so as to evaporate rinsing liquid.

Furthermore, as necessary, a post-crosslinking step for further crosslinking the recording layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound. In the present invention, the structures of N═O of an amine oxide compound and P═O of a phosphine oxide compound are considered to be N⁺—O⁻ and P⁺—O⁻ respectively.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total weight of the rinsing liquid, and more preferably 0.05 to 10 mass %.

The cylindrical printing plate of the present invention having a relief layer may be produced as described above.

From the viewpoint of satisfying suitability for various aspects of cylindrical printing, such as abrasion resistance and ink transfer properties, the thickness of the relief layer of the cylindrical printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the cylindrical printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The cylindrical printing plate of the present invention is particularly suitable for printing by a flexographic printer using an aqueous ink, but printing is also possible when it is carried out by a letterpress printer using any of aqueous and UV inks, and printing is also possible when it is carried out by a flexographic printer using a UV ink.

In accordance with the present invention, there can be provided a cylindrical printing plate precursor that is excellent in terms of thickness precision and adhesive strength and a process for producing same.

### EXAMPLES

The present invention is explained in further detail below by reference to Examples, but the present invention should not be construed as being limited to these Examples. ‘Parts’ in the description below means ‘parts by mass’ and ‘%’ means ‘mass %’ unless otherwise specified.

### Examples 1 to 19, and Comparative Examples 1 to 6

### 1. Preparation of Crosslinkable Resin Composition

A three-necked flask equipped with a stirring blade and a condenser was charged with 50 parts of ‘Denka Butyral #3000-2’ (Denki Kagaku Kogyo Kabushiki Kaisha, polyvinyl butyral derivative, Mw=90,000) as a polymer and 47 parts of propylene glycol monomethyl ether acetate as a solvent, and the polymer was dissolved by heating at 70° C. for 120 minutes while stirring. Subsequently, the solution was set at 40° C., 15 parts of monomer (M-1) (structure below, Shin-Nakamura Chemical Co., Ltd.) as a polymerizable compound (polyfunctional compound), 8 parts of Blemmer LMA (NOF Corporation) as a polymerizable compound (monofunctional compound: lauryl methacrylate), 1.6 parts of t-butyl peroxybenzoate (product name: Perbutyl Z, NOF Corporation) as a polymerization initiator, and 1 part of Ketjen Black EC600JD (carbon black, Lion Corporation) as a photothermal conversion agent were further added, and stirring was carried out for 30 minutes. Subsequently, 15 parts of compound (S-1) (structure shown below; available from Shin-Etsu Chemical Co., Ltd. under the product name KBE-846) and 0.4 parts of phosphoric acid as a catalyst were added, and stirring was carried out at 40° C. for 10 minutes. This procedure gave flowable coating solution 1 for a crosslinkable relief-forming layer (crosslinkable resin composition for laser engraving).

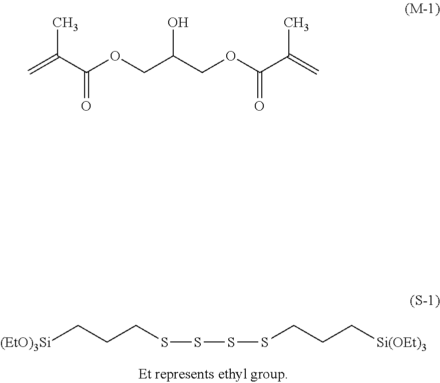

### 2. Preparation of Printing Plate Precursor Sheet (Cured Resin Sheet)

### 2-1. Preparation of Crosslinked Resin Sheet

A spacer (frame) having a predetermined thickness was placed on a PET substrate, and coating solution 1 for a crosslinkable relief-forming layer obtained above was gently cast so that it did not overflow from the spacer (frame) and dried in an oven at 70° C. for 3 hours to thus provide a relief-forming layer having a thickness of about 0.80 mm in the case in which the thickness of the printing plate precursor in Table 1 was 1.14 mm and a relief-forming layer having a thickness of about 1.35 mm in the case in which the thickness of the printing plate precursor in Table 1 was 1.70 mm, thereby producing an uncrosslinked resin sheet. In Example 19, the thickness of the relief-forming layer was changed so that the thickness of the printing plate precursor became the thickness described in Table 1.

The relief-forming layer of the resin sheet thus obtained was heated at 80° C. for 3 hours and further at 100° C. for 3 hours to thus carry out thermal crosslinking of the relief-forming layer, thereby giving a crosslinked resin sheet.

### 2-2. Adhesion of PET Support

The crosslinked resin sheet thus obtained by thermal crosslinking was coated with the adhesive composition described below at a thickness of 120 μm, a 0.23 mm thick PET support was then adhered thereto using a nip roller, and 20 seconds later the adhesive was cured from the PET support side using a UV exposure machine (ECS-151U UV exposure machine, Eye Graphics Co., Ltd., metal halide lamp, 1,500 mJ/cm², 14 sec exposure) with an exposure of 1,000 mJ/cm², thereby producing a printing plate precursor sheet.

### <Constitution of Adhesive Composition>

2-Hydroxypropyl acrylate (Osaka Organic Chemical Industry Ltd.): 52 parts by mass
Trimethylolpropane triacrylate (Shin-Nakamura Chemical Co., Ltd.): 40 parts by mass
1-Hydroxycyclohexyl phenyl ketone (Ciba Specialty Chemicals): 8 parts by mass

### 3. Preparation of Sleeve-Shaped Relief Printing Plate Precursor (Cylindrical Printing Plate Precursor)

Cylindrical printing plate precursors of the Examples and Comparative Examples were produced by the method below so as to give the embodiments shown in Table 1 and FIG. 3, FIG. 4, and FIG. 7.

A printing plate precursor sheet obtained was cut into a width of 200 mm and a length of 510 to 550 mm according to the width of an overlap margin. The surface of a section that would become an overlap margin, which was on the inside, with a width of 5 to 25 mm from each of opposite ends parallel to the shorter direction of the printing plate precursor sheet was partially removed as follows.

Printing plate precursor sheets were set in a CNC machine (Okuma Corporation) so that the face layered with the PET support was down, and an overlap margin part on the winding start end side was machined so as to give the embodiments shown in Table 1, FIG. 3, and FIG. 4. The angle α in FIG. 11 was 30°. Subsequently, columnar holes having a diameter of 0.5 to 3.5 mm were stamped so as to give embodiments A to E shown in FIG. 7 to FIG. 11 and Table 1.

Subsequently, with the face layered with the PET support now uppermost, and in the same step as above, an overlap margin part on the winding finish end side was machined so as to give the embodiments shown in Table 1, FIG. 3, and FIG. 4, and columnar holes having a diameter of 0.5 to 3.5 mm were then stamped so as to give embodiments A to E shown FIG. 7 to FIG. 11 and Table 1.

In the embodiment of A of FIG. 7, holes on four corners were formed so as to be spaced by 0.10 mm from the end part in the circumferential direction of the overlap margin part (left-and-right direction in FIG. 7, the same in FIG. 8 to FIG. 11) and 1.00 mm from the end part in the width direction of the overlap margin part (up-and-down direction in FIG. 7, the same in FIG. 8 to FIG. 11), and the other holes were formed at equal intervals in the circumferential direction and the width direction.

In the embodiment of B of FIG. 8, holes were formed so as to be spaced from each other by 0.50 mm in the circumferential direction and the width direction in a middle area of the overlap margin part (equal distance from each side of the opposite ends in the circumferential direction and equal distance from each side of the opposite ends in the width direction).

In the embodiment of C of FIG. 9, holes on four corners were formed so as to be spaced by 0.10 mm from the end part in the circumferential direction of the overlap margin part and 1.00 mm from the end part in the width direction of the overlap margin part, and holes in a middle area were formed so as to be spaced from each other in the middle area of the overlap margin part by 0.5 mm in the width direction and so that centers of the holes were aligned in the middle in the circumferential direction of the overlap margin part.

Furthermore, in the embodiment of D of FIG. 10, holes on four corners were formed so as to be spaced by 0.10 mm from the end part in the circumferential direction of the overlap margin part and 1.00 mm from the end part in the width direction of the overlap margin part, and the other holes were formed on the periphery at equal intervals in the circumferential direction and the width direction.

In the embodiment of E of FIG. 11, holes on four corners were formed so as to be spaced by 0.10 mm from the end part in the circumferential direction of the overlap margin part and 1.00 mm from the end part in the width direction of the overlap margin part, and the other holes were formed on the periphery at equal intervals in the circumferential direction and a direction of 30° relative to the width direction.

An adhesive tape (Lohmann, DupuloFLEX 5.1 Plus) was affixed as a marker to an outer face of a nickel print sleeve (thickness 1.5 mm) having an outer circumference of 500 mm, and the printing plate precursor was carefully affixed. Subsequently, the uncured crosslinkable resin composition was poured into each of the communication hole parts, which were the stamped columnar holes above, and the surface was leveled using a spatula. The entire cylindrical printing plate precursor including the uncured curable resin was heated at 100° C. for 1 hour to thus form the joining parts, thereby giving a cylindrical printing plate precursor.

### 4. Laser Engraving

The crosslinked relief-forming layer of the cylindrical printing plate precursor thus obtained was engraved using the two types of laser below.

As a carbon dioxide laser engraving machine, for engraving by irradiation with a laser, an ML-9100 series high quality CO₂ laser marker (Keyence) was used. After a protective film was peeled off from the printing plate precursor 1 for laser engraving, a 1 cm square solid printed area was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed area was raster-engraved using the semiconductor laser engraving machine under conditions of a laser output of 7.5 W, a head speed of 409 mm/sec, and a pitch setting of 2,400 DPI.

When the thickness of the relief printing plate (printing plate precursor) was 1.14 mm, the thickness of the relief layer was 0.80 mm, and when the thickness of the relief printing plate (printing plate precursor) was 1.70 mm, the thickness of the relief layer was 1.35 mm.

Furthermore, when the Shore A hardness of the relief layer was measured by the above measurement method, it was found to be 75°.

As hereinabove described, a cylindrical relief printing plate comprising a relief layer above the surface of any substrate such as a support was obtained.

### <Evaluation of Printing Plate>

### 1. Evaluation of Positional Precision

An area around the overlap margin part of the printing plate precursor was cut out, and the surface of the engraving face side of the start end part of the overlap margin part was examined using a microscope (VHX-1000, Keyence Corporation) at a magnification of 100.

The positional precision was evaluated as excellent when there was as little gap as possible in the start end part; evaluation criteria were 3 for one in which a gap was observed throughout the face in the width direction, 2 for one with almost no gap, and 1 for one without a gap.

### 2. Evaluation of Thickness Precision

An area around the overlap margin part of the printing plate precursor was cut out, and cross-sections of 10 positions each of the joining part and the overlap margin part other than the joining part were examined using a microscope (VHX-1000, Keyence Corporation) at a magnification of 100, thus determining the thickness.

The smaller the value calculated from (average value of 10 positions in joining part)−(average value of 10 positions in overlap margin part other than in joining part), the better the thickness precision; evaluation criteria were 3 for at least 50 μm, 2 for at least 20 μm but less than 50 μm, and 1 for less than 20 μm.

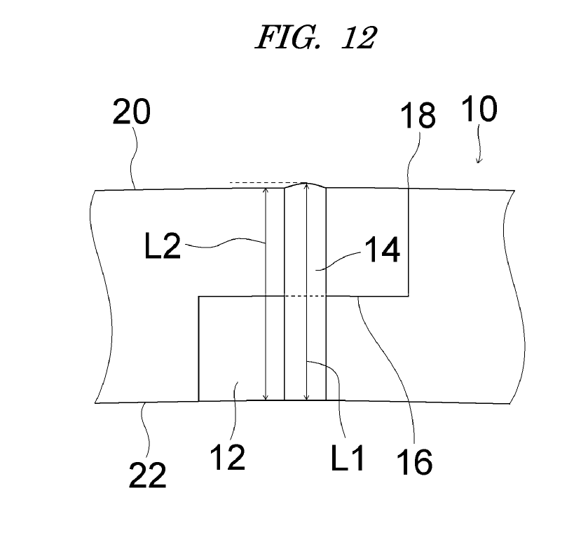

As shown in FIG. 12, the thickness of the joining part and the thickness of the overlap margin part other than the joining part correspond to L1 and L2 respectively.

### 3. Evaluation of Adhesive Strength

A sleeve printing plate that had been obtained was set in a printer (Model ITM-4, IYO KIKAI SEISAKUSHO Co., Ltd.), as the ink undiluted Aqua SPZ16 Red aqueous ink (Toyo Ink Manufacturing Co., Ltd.) was used, printing was started using Full Color Form M 70 (Nippon Paper Industries Co., Ltd., thickness 100 μm) as the printing paper, and printing was carried out at a speed of 350 m/min.

The adhesive strength was evaluated as excellent when there was no peel-off or floating; evaluation criteria were, after printing 50,000 m, 3 for one in which the joining part had peeled off, 2 for one in which part of the joining part had peeled off but there was no actual damage to image quality, 1 for one in which there was no peel-off but part of the joining part was floating, and 0 for one in which there was no peel-off and no floating.

The evaluation results of each of the Examples and Comparative Examples are given in Table 1. With regard to the description of the arrangement of the joining parts, when the arrangement was A (FIG. 7) and B (FIG. 8), the number is given as (number in circumferential direction)×(number in width direction). When the arrangement was C (FIG. 9), the number is given as 4 (holes on four corners)+(number in width direction of middle area). When the arrangement was D (FIG. 10), the number is given as (total number in circumferential direction excluding four corners)+(total number in width direction including four corners). When the arrangement was E (FIG. 11), the number is given as (number in circumferential direction)×(number in direction at angle α relative to width direction).

TABLE 1

| | Printing | | | | | | | | | | | |
|---|---|---|---|---|---|---|---|---|---|---|---|---|
| | plate | Overlap margin part | | | | | | | Area | | | |
| | precursor | | Cross- | | Joining part | | | | ratio | | | |
| | Thickness | Width | sectional | Surface | Size | Arrange- | | | Area B/ | Positional | Thickness | Adhesive |
| | (mm) | (mm) | shape | shape | (mm) | ment | Number | Rows | Area A | precision | precision | strength |
| Ex. 1 | 1.14 | 5 | a-1 | b-1 | 2.0 | A | 30 | 2 × 15 | 9% | 1 | 1 | 0 |
| Ex. 2 | 1.14 | 10 | a-1 | b-1 | 2.0 | A | 60 | 4 × 15 | 9% | 1 | 1 | 0 |
| Ex. 3 | 1.14 | 25 | a-1 | b-1 | 2.0 | A | 144 | 12 × 12 | 9% | 2 | 1 | 0 |
| Ex. 4 | 1.14 | 10 | a-1 | b-1 | 1.0 | A | 240 | 8 × 30 | 9% | 1 | 1 | 0 |
| Ex. 5 | 1.14 | 10 | a-1 | b-1 | 3.0 | A | 24 | 3 × 8 | 8% | 1 | 2 | 0 |
| Ex. 6 | 1.14 | 10 | a-1 | b-1 | 2.0 | A | 32 | 4 × 8 | 5% | 1 | 1 | 2 |
| Ex. 7 | 1.14 | 10 | a-1 | b-1 | 2.0 | A | 44 | 4 × 11 | 7% | 1 | 1 | 1 |
| Ex. 8 | 1.14 | 10 | a-1 | b-1 | 2.0 | A | 256 | 4 × 64 | 40% | 1 | 1 | 1 |
| Ex. 9 | 1.14 | 10 | a-1 | b-1 | 2.4 | E | 348 | 4 × 87 | 79% | 2 | 2 | 2 |
| Ex. 10 | 1.14 | 10 | a-2 | b-1 | 2.0 | A | 60 | 4 × 15 | 9% | 1 | 1 | 1 |
| Ex. 11 | 1.14 | 10 | a-3 | b-1 | 2.0 | A | 60 | 4 × 15 | 9% | 1 | 1 | 0 |
| Ex. 12 | 1.14 | 10 | a-4 | b-1 | 2.0 | A | 32 | 4 × 8 | 5% | 1 | 1 | 0 |
| Ex. 13 | 1.14 | 10 | a-4 | b-1 | 2.0 | A | 60 | 4 × 15 | 9% | 1 | 1 | 0 |
| Ex. 14 | 1.14 | 10 | a-1 | b-2 | 2.0 | A | 60 | 4 × 15 | 9% | 1 | 1 | 0 |
| Ex. 15 | 1.14 | 10 | a-1 | b-1 | 2.0 | B | 60 | 3 × 20 | 9% | 1 | 2 | 1 |
| Ex. 16 | 1.14 | 10 | a-1 | b-1 | 2.0 | C | 60 | 4 + 56 | 9% | 1 | 2 | 0 |
| Ex. 17 | 1.14 | 10 | a-1 | b-1 | 2.0 | D | 60 | 4 + 56 | 9% | 1 | 1 | 0 |
| Ex. 18 | 1.14 | 10 | a-3 | b-1 | 2.0 | D | 60 | 4 + 56 | 9% | 1 | 1 | 0 |
| Ex. 19 | 1.70 | 10 | a-1 | b-1 | 2.0 | A | 60 | 4 × 15 | 9% | 1 | 1 | 1 |
| Comp. | 1.14 | 4 | a-1 | b-1 | 2.0 | A | 22 | 2 × 11 | 9% | 1 | 1 | 3 |
| Ex. 1 | | | | | | | | | | | | |
| Comp. | 1.14 | 26 | a-1 | b-1 | 2.0 | A | 144 | 12 × 12 | 9% | 3 | 1 | 0 |
| Ex. 2 | | | | | | | | | | | | |
| Comp. | 1.14 | 10 | a-1 | b-1 | 0.5 | A | 936 | 18 × 52 | 9% | 1 | 3 | 0 |
| Ex. 3 | | | | | | | | | | | | |
| Comp. | 1.14 | 10 | a-1 | b-1 | 3.5 | A | 18 | 2 × 9 | 9% | 3 | 3 | 0 |
| Ex. 4 | | | | | | | | | | | | |
| Comp | 1.14 | 10 | a-1 | b-1 | 2.0 | A | 24 | 4 × 6 | 4% | 1 | 1 | 3 |
| Ex. 5 | | | | | | | | | | | | |
| Comp. | 1.14 | 10 | a-1 | b-1 | 2.4 | E | 364 | 4 × 91 | 82% | 3 | 3 | 3 |
| Ex. 6 | | | | | | | | | | | | |

### BRIEF DESCRIPTION OF DRAWINGS

10: Cylindrical printing plate precursor, 12: overlap margin part, 14: joining part, 16: end part (cut face) of cured resin sheet, 18: start end part, 20: engraving face, 22: support face, D: circumferential direction of cylindrical printing plate precursor, L1: thickness of joining part, L2: thickness of overlap margin part other than joining part

What is claimed is:

1. A cylindrical printing plate precursor comprising a cured resin sheet formed into a cylindrical shape, the cylindrical printing plate precursor comprising
an overlap margin part comprising opposite end parts of the cured resin sheet superimposed on one another,
each end part of the cured resin sheet in the overlap margin part having a thickness that is smaller than the thickness of the cured resin sheet other than in the overlap margin part, and
a joining part, in the overlap margin part, in which a hole providing communication between the opposite end parts of the cured resin sheet is filled with a cured resin,
the overlap margin part having a width of least 5 mm but no greater than 25 mm,
the joining part having a size of at least 1 mm but no greater than 3 mm, and
the joining part having a cross-sectional area in the plate surface direction of at last 5% but less than 80% relative to the cross-sectional area in the plate surface direction of the overlap margin part.

2. The cylindrical printing plate precursor according to claim 1, wherein the number of joining parts is 20 to 600.

3. The cylindrical printing plate precursor according to claim 1, wherein the number of joining parts is 50 to 200.

4. The cylindrical printing plate precursor according to claims 1, wherein the joining part has a columnar shape.

5. The cylindrical printing plate precursor according to claims 1, wherein the cylindrical printing plate precursor is a cylindrical printing plate precursor for laser engraving.

6. A process for producing a cylindrical printing plate precursor, comprising
(1) a step of preparing a cured resin sheet,
(2) a step of forming a part of the cured resin sheet that becomes an overlap margin,
(3) a step of forming a hole providing communication within an overlap margin part in which an overlap margin on the winding start end side of the cured resin sheet and an overlap margin on the winding finish end side are superimposed on one another, and
(4) a step of forming a joining part by filling the hole with a cured curable resin composition,
the overlap margin part having a width of at least 5 mm but no greater than 25 mm,
the joining part having a size of at least 1 mm but no greater than 3 mm, and
the hole having a cross-sectional area in the plate surface direction of at last 5% but less than 80% relative to the cross-sectional area in the plate surface direction of the overlap margin part.

7. The process for producing a cylindrical printing plate precursor according to claim 6, wherein step (4) comprises a step of injecting an uncured curable resin composition into the hole and a step of curing the uncured curable resin composition.

8. The process for producing a cylindrical printing plate precursor according to claim 6, wherein any one of step (2) to step (4) is a step that is carried out while fixing at least one end part of the cured resin sheet.

9. The process for producing a cylindrical printing plate precursor according to claims 6, wherein the curable resin composition is a thermally curable resin composition.

10. The process for producing a cylindrical printing plate precursor according to claims 6, wherein the hole is a through hole extending through the two overlap margins.

11. The process for producing a cylindrical printing plate precursor according to claims 6, wherein the number of joining parts is 20 to 600.

12. The process for producing a cylindrical printing plate precursor according to claims 6, wherein the number of joining parts is 50 to 200.

13. The process for producing a cylindrical printing plate precursor according to claims 6, wherein the joining part has a columnar shape.

14. The process for producing cylindrical printing plate precursor according to claims 6, wherein the cylindrical printing plate precursor is a cylindrical printing plate precursor for laser engraving.

15. A process for making a cylindrical printing plate, comprising an engraving step of laser-engraving the cylindrical printing plate precursor according to claims 1.

16. A process for making a cylindrical printing plate, comprising an engraving step of laser-engraving the cylindrical printing plate precursor according to claim 6.

17. A cylindrical printing plate made by the making process according to claim 15.
